(19) United States
(12) Patent Application Publication
(10) Pub. No.: US 2025/0100184 A1
(43) Pub. Date: Mar. 27, 2025

(54) Concrete-casting Mold System

(71) Applicant: UTAH GRANITE WORKS LLC, Salem, UT (US)

(72) Inventors: Jared Antonino, Spanish Fork, UT (US); Zackery Antonino, Spanish Fork, UT (US)

(21) Appl. No.: 18/755,646

(22) Filed: Jun. 26, 2024

Related U.S. Application Data
(60) Provisional application No. 63/523,321, filed on Jun. 26, 2023.

(51) Int. Cl. B28B 7/02; B28B 7/00; B28B 7/34; B28B 23/00

(52) U.S. Cl. CPC B28B 7/02; B28B 7/0014; B28B 7/34; B28B 7/348; B28B 23/005

(57) ABSTRACT

A configurable mold for concrete-casting, methods of use and method using the configurable mold.

### CROSS-REFERENCE TO RELATED APPLICATIONS

This application claims the benefit of U.S. Provisional Application Ser. No. 63/523,321 filed Jun. 26, 2023, which is incorporated by reference herein in its entirety.

### STATEMENT REGARDING FEDERALLY SPONSORED RESEARCH OR DEVELOPMENT

(NOT APPLICABLE)

### BACKGROUND OF THE INVENTION

Forms have been used for shaping poured concrete to form a concrete slab, a space needs to be prepared with a form, usually comprised of a solid material that forms walls and a base to keep the liquid concrete in a designated shape. When the concrete dries, it will retain the shape of the form set up around it and the form can be removed and/or disposed of. During the concrete drying process, the outward surface of the concrete needs to be continually shaped and smoothed to ensure a smooth and clean surface when it is solidified. This process often may take several hours and usually includes repeatedly moving the concrete around to release air bubbles and smoothing any bumps or scratches on the surface. In some cases, the concrete slab cannot be poured and solidified in the same place as its final destination. In this circumstance, the traditional method is to build forms, such as by using planks of wood to form a frame, on a separate solid and flat surface, put down newspaper or another temporary bottom, pour the concrete over it into the form, and continue the aforementioned process. Afterward, the form can be removed, and the concrete slab can be moved to the desired location. This way of preparing concrete slabs is especially prevalent when making concrete headstones, as many cemeteries will not allow forms to be erected and concrete poured directly over a grave site. Typically, these concrete headstone slabs also require the placement of various other objects onto the top surface of the wet concrete, making the finishing process more complex and time-consuming. A need exists for an improved form, method of creating the form, and method of using the form that would reducing the work required to construct concrete slabs with a finished surface.

### SUMMARY

These and other objects and features of the present invention will become more fully apparent from the following description and appended embodiment s or may be learned by the practice of the invention as set forth hereinafter. The invention may be used with various methods of preparing various types and sizes of pieces of concrete. This disclosure is directed at embodiments of a template form for creating a concrete-casting mold, methods of using the template form to create a concrete-casting mold, concrete-casting molds, and methods of using concrete-casting molds. Any reference numbers that are included in the embodiments are to be disregarded when interpreting the embodiments.

Various detachable barriers walls are depicted. In preferred embodiments, the wall which may also be referred to as a divider wall or a divider may have 2 side edges that are sloped to substantially match the slope of the corresponding walls of the mold such that when the barrier wall is inserted into a mold such as a plastic mold or a metal mold then the side edges of the barrier wall comprising a minor face may be flushed against the nearest wall of the mold such that when wet concrete that is the mold having at least one then the barrier wall may act to prevent the concrete from seeping past the detachable barrier.

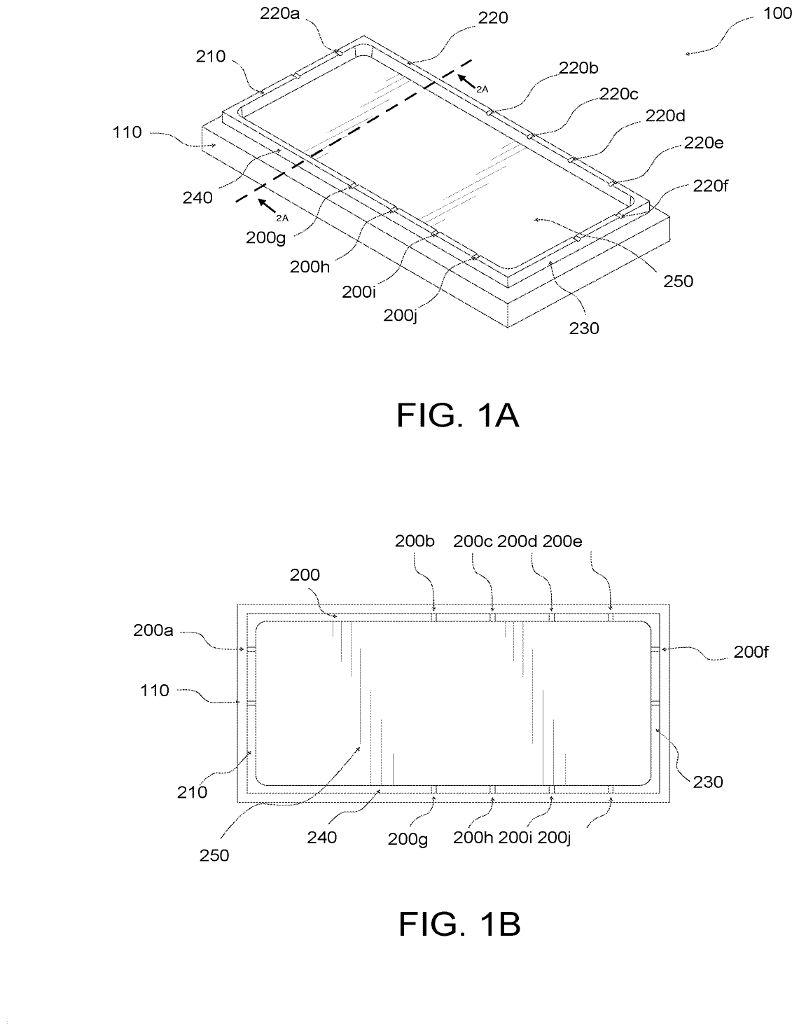

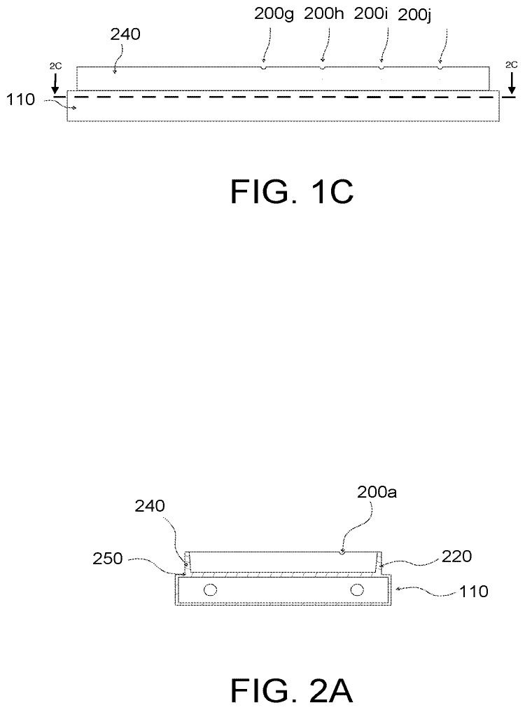

FIG. 1A shows a perspective view of an embodiment of a template form¹. ¹ Plastic or fiberglass or other materials

FIG. 1B is a top view of an embodiment of a template form.

FIG. 1C is a side view of an embodiment of a template form.

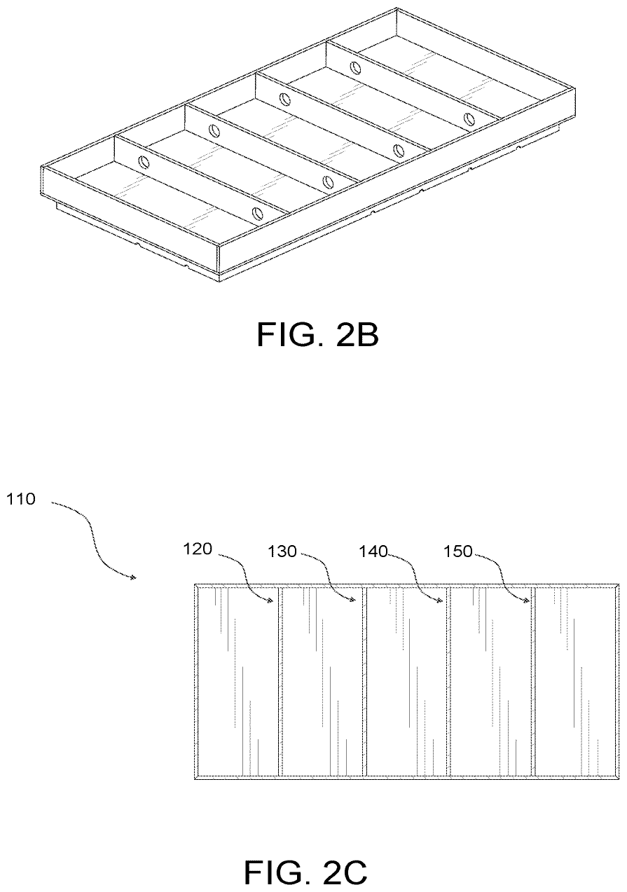

FIG. 2A is a cross-sectional side view of an embodiment of a template form; the plane upon which the cross-sectional view has been taken is indicated by a broken line in FIG. 1A.

FIG. 2B is a perspective bottom view of an embodiment of a template form.

FIG. 2C is a cross-sectional bottom view of an embodiment of a template form taken from a plane shown in FIG. 1C.

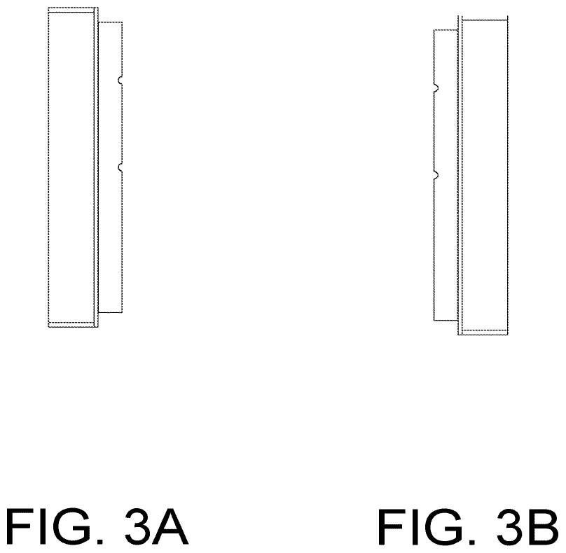

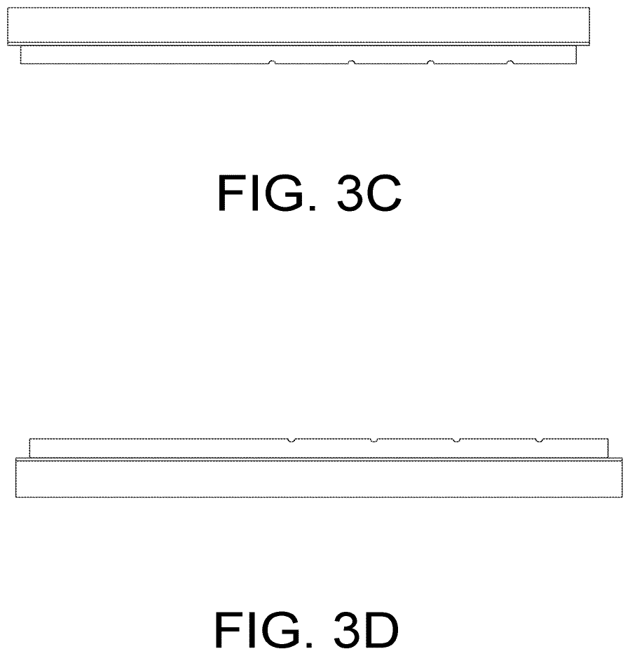

FIG. 3A is a rear view of the embodiment of the template form shown in FIG. 1A.

FIG. 3B is a front view of the embodiment of the template form shown in FIG. 1A.

FIG. 3C is a side view of the embodiment of the template form shown in FIG. 1A.

FIG. 3D is a side view of the embodiment of the template form shown in FIG. 1A.

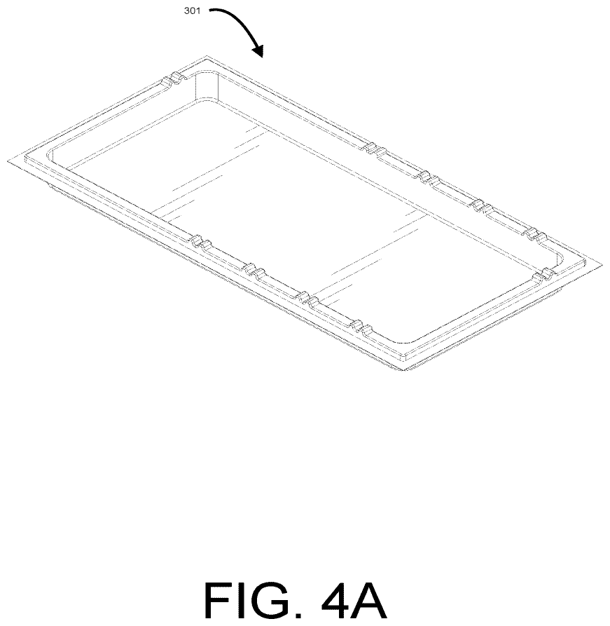

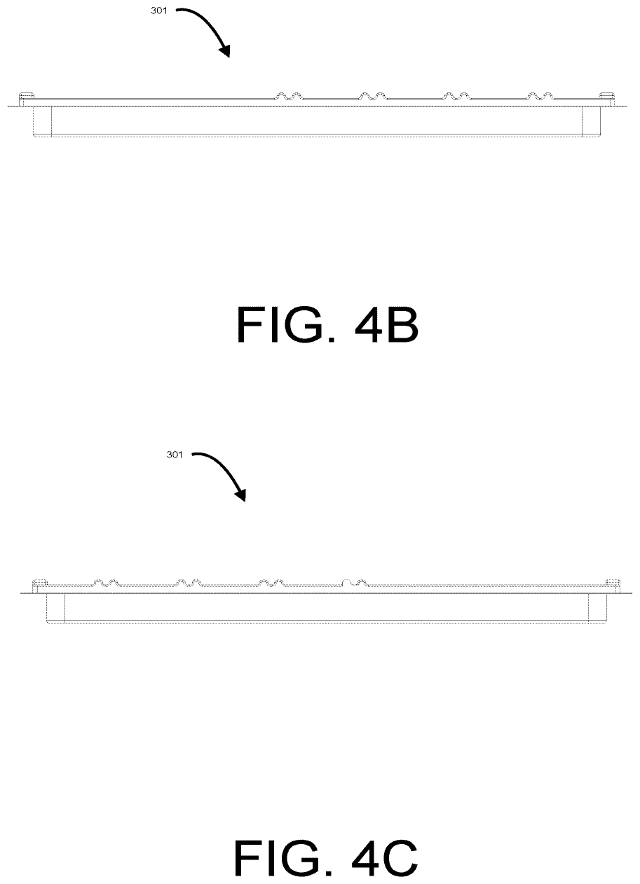

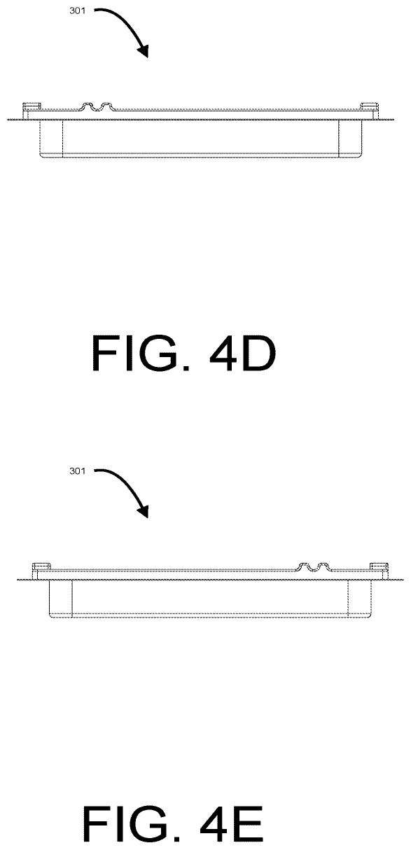

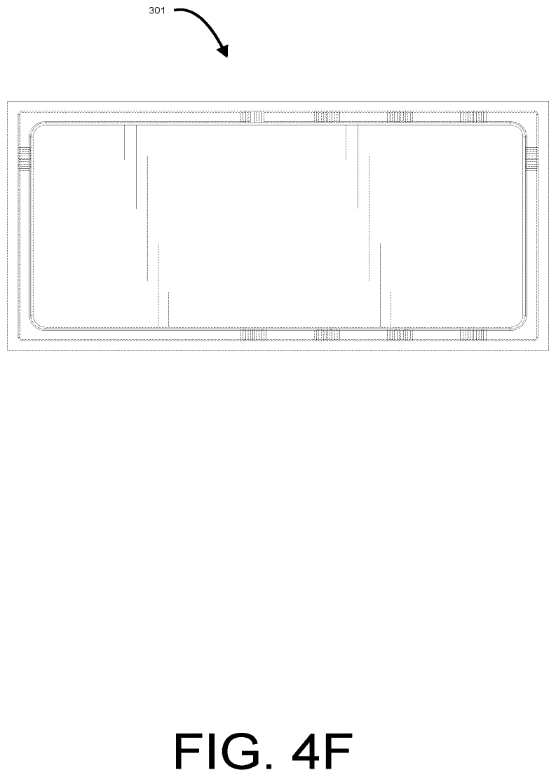

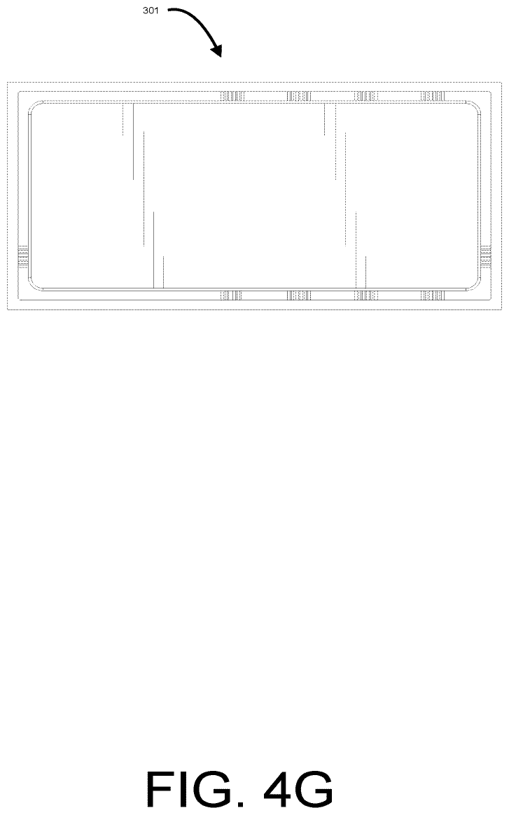

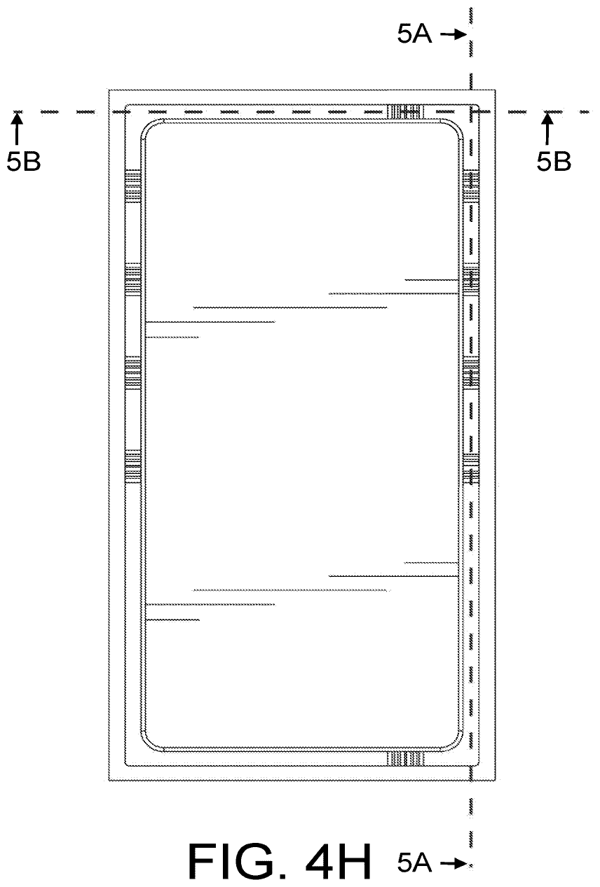

FIG. 4A is a top perspective view of an embodiment of a concrete-casting mold.

FIG. 4B is a side view of an embodiment of a concrete-casting mold.

FIG. 4C is a side view of an embodiment of a concrete-casting mold.

FIG. 4D is a rear view of an embodiment of a concrete-casting mold.

FIG. 4E is a front view of an embodiment of a concrete-casting mold.

FIG. 4F is a top view of an embodiment of a concrete-casting mold.

FIG. 4G is a bottom view of an embodiment of a concrete-casting mold.

FIG. 4H is a top view of an embodiment of a concrete-casting mold showing cross-sectional lines.

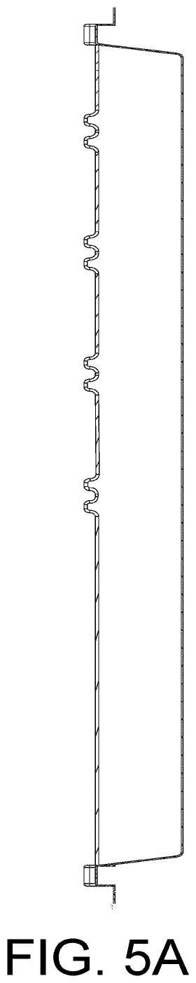

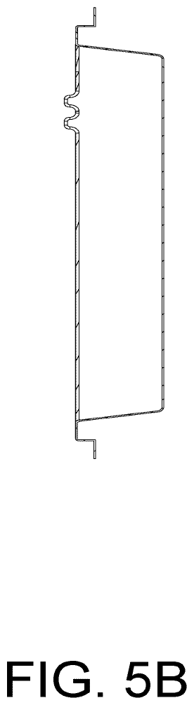

FIG. 5A is a cross-sectional view of the concrete-casting mold.

FIG. 5B is also a cross-sectional view of the concrete-casting mold.

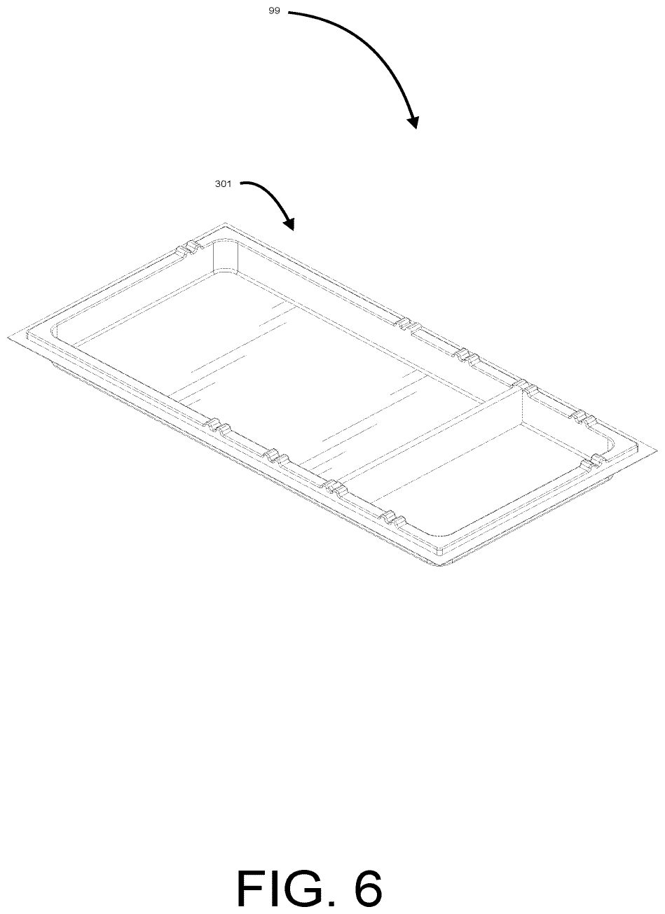

FIG. 6 is a perspective view of the concrete-casting mold having a detachable short barrier inserted;

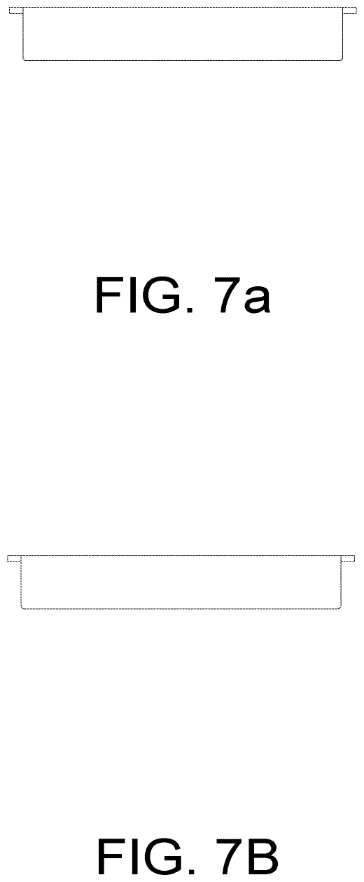

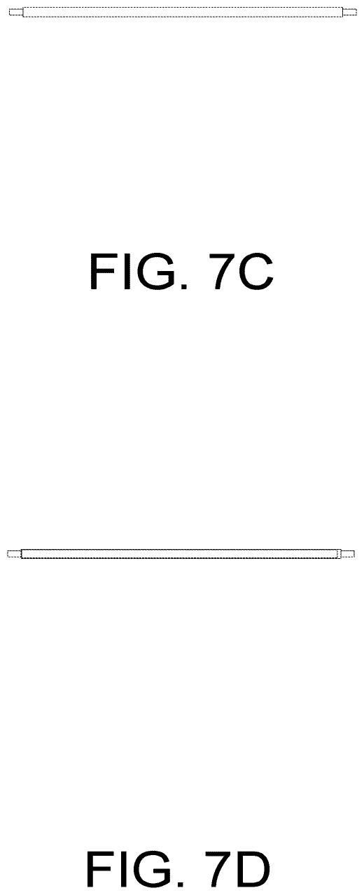

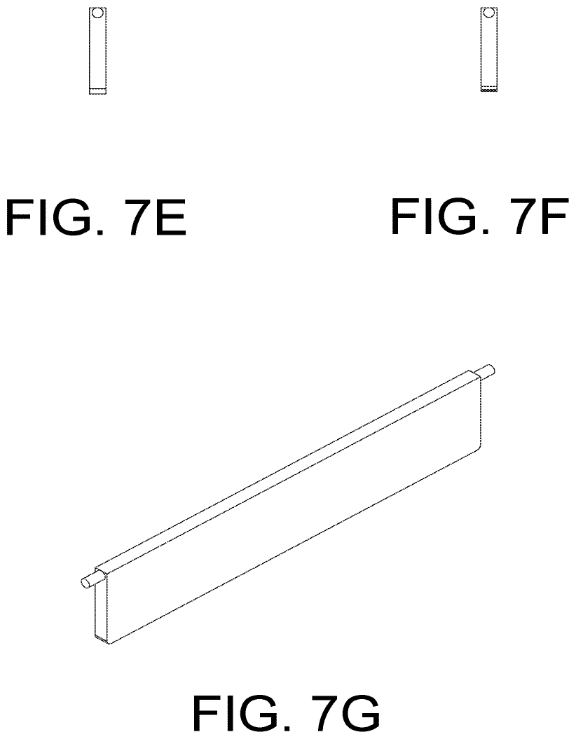

FIG. 7a is a left side view of the detachable short barrier;

FIG. 7B is a right-side view of the detachable short barrier;

FIG. 7C is a top view of the detachable short barrier;

FIG. 7D is a bottom view of the detachable short barrier;

FIG. 7E is a front view of the detachable short barrier;

FIG. 7F is a rear view of the detachable short barrier;

FIG. 7G is a perspective view of the detachable short barrier;

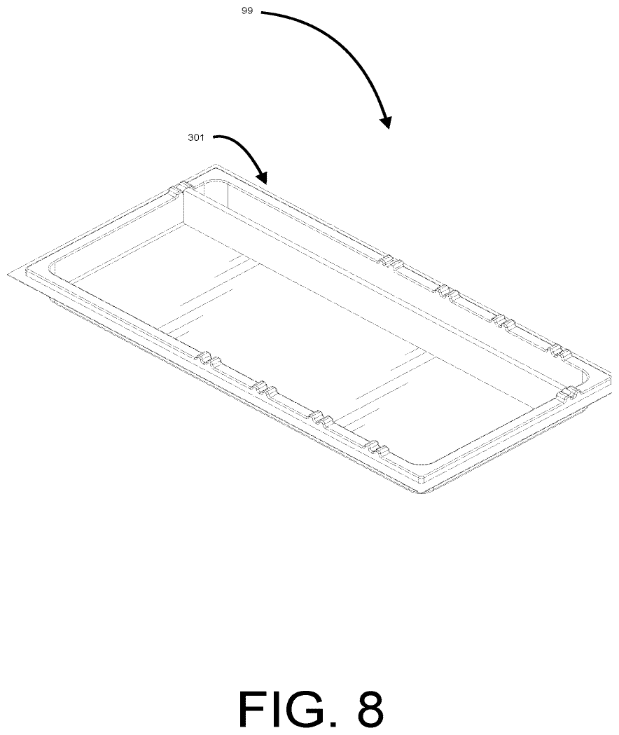

FIG. 8 is a perspective view of the concrete-casting mold having a detachable long barrier inserted;

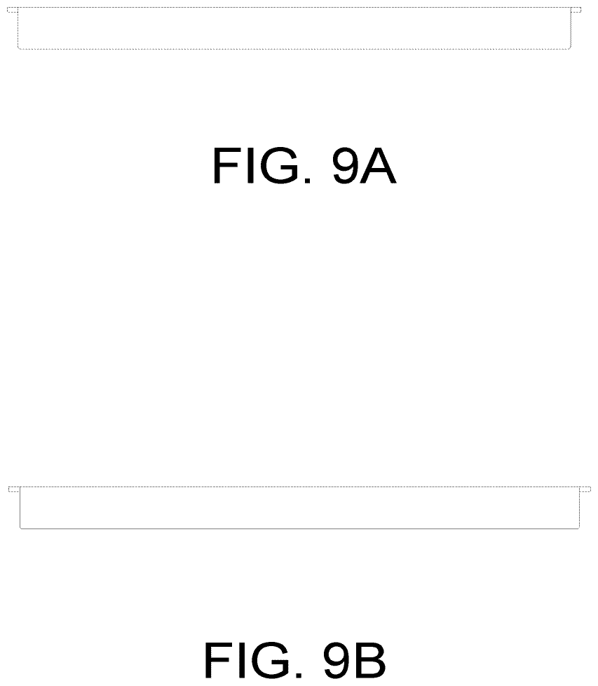

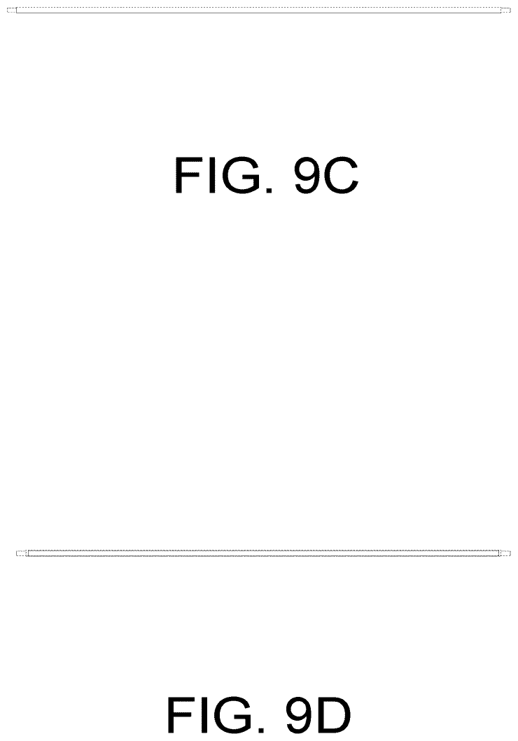

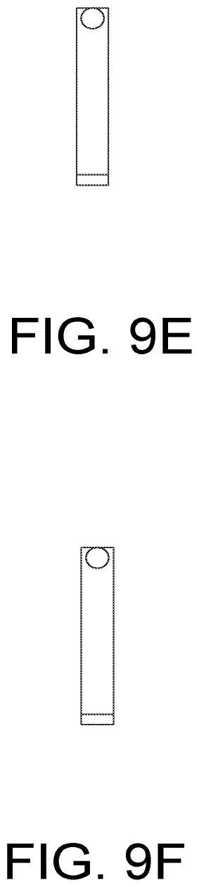

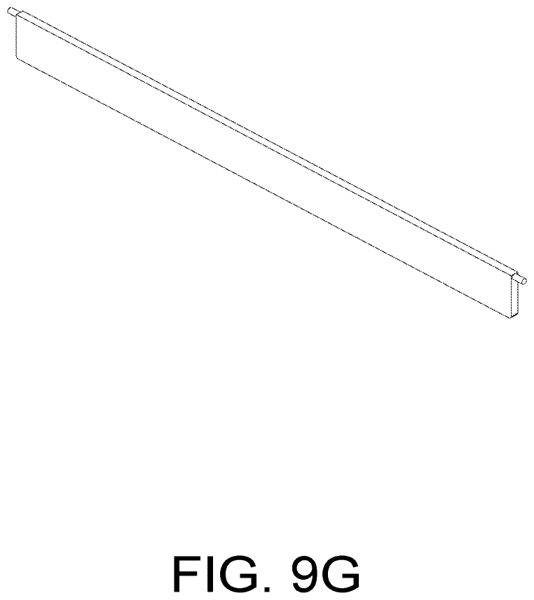

FIG. 9A is a left side view of the detachable long barrier;

FIG. 9B is a right-side view of the detachable long barrier;

FIG. 9C is a top view of the detachable long barrier;

FIG. 9D is a bottom view of the detachable long barrier;

FIG. 9E is a front view of the detachable long barrier;

FIG. 9F is a rear view of the detachable long barrier;

FIG. 9G is a perspective view of the detachable long barrier.

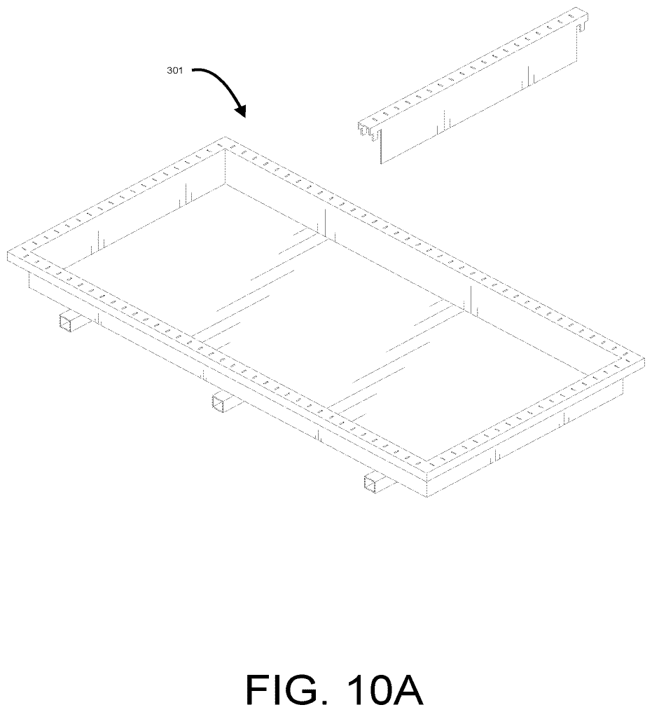

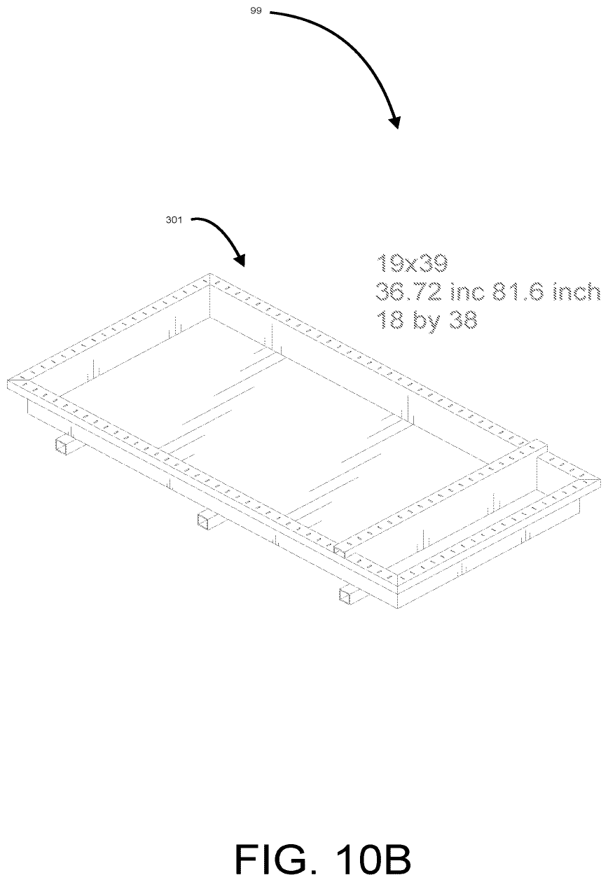

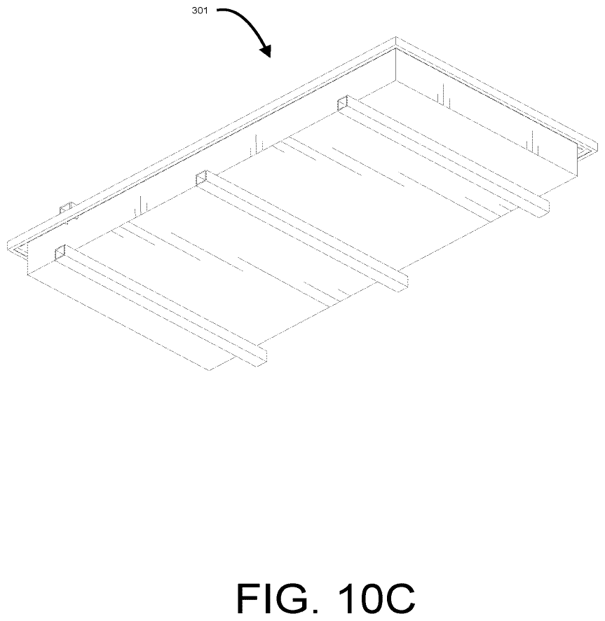

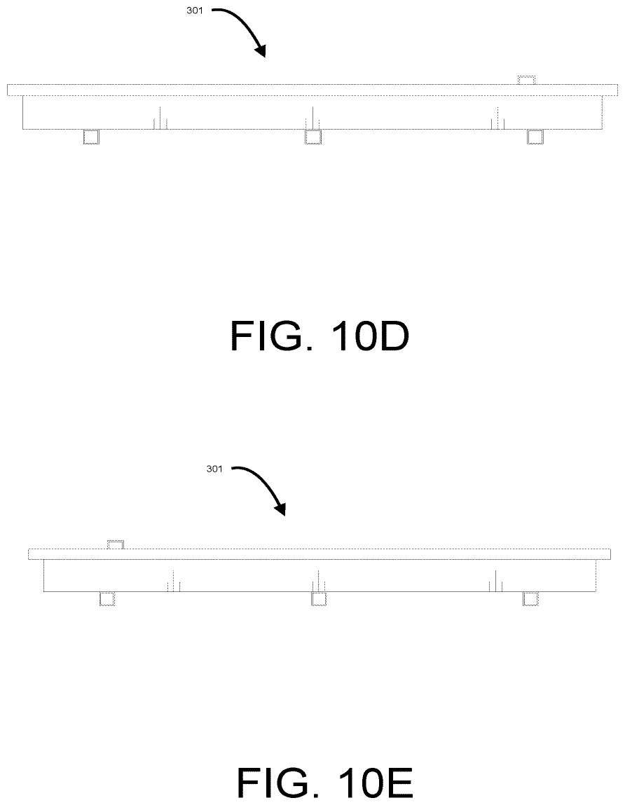

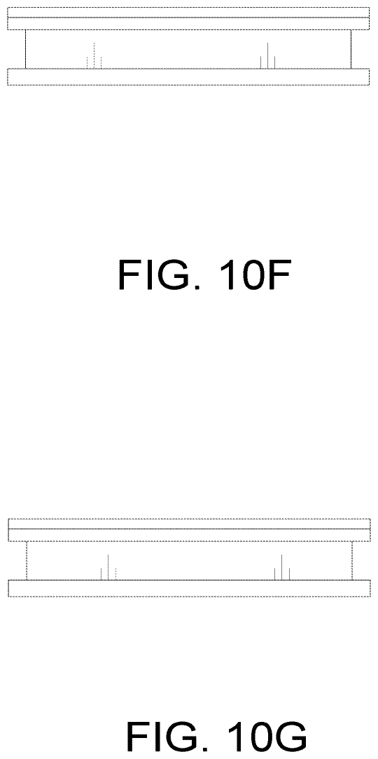

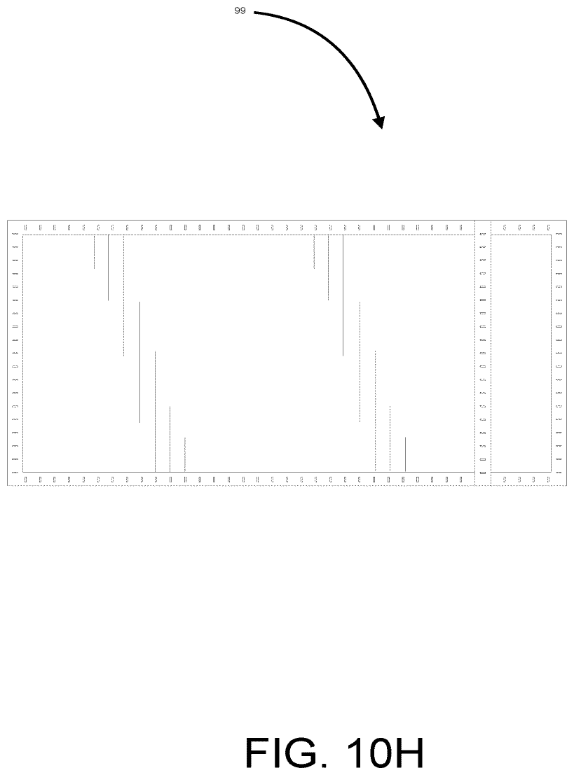

FIG. 10A is a perspective view of a metal concrete-casting mold having a detachable short barrier in a detached position.

FIG. 10B is a perspective view of the metal concrete-casting mold wherein the detachable short barrier is in an attached position, such that the concrete-casting mold and the attached detachable short barrier combined are deemed the concrete-casting mold system (the same status also applies to the non-metal concrete-casting molds herein).

FIG. 10C is a bottom perspective view of the concrete-casting mold system of FIG. 10B;

FIG. 10D is a side view of the concrete-casting mold system of FIG. 10B;

FIG. 10E is a side view of the concrete-casting mold system of FIG. 10B;

FIG. 10F is a rear view of the concrete-casting mold system of FIG. 10B;

FIG. 10G is a front view of the concrete-casting mold system of FIG. 10B;

FIG. 10H is a top view of the concrete-casting mold system of FIG. 10B;

FIG. 10I is a bottom view of the concrete-casting mold system of FIG. 10B;

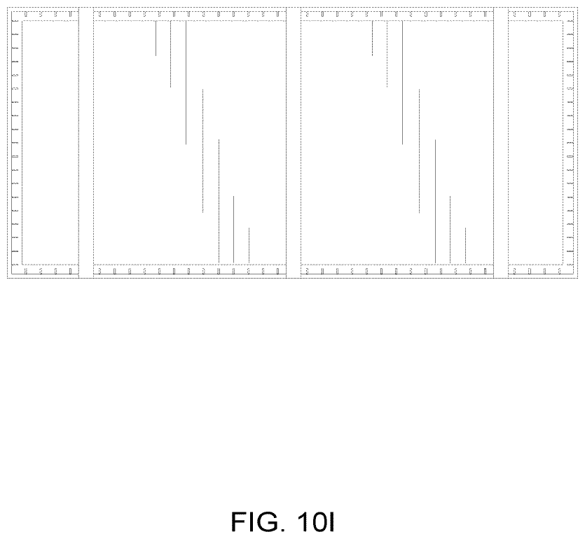

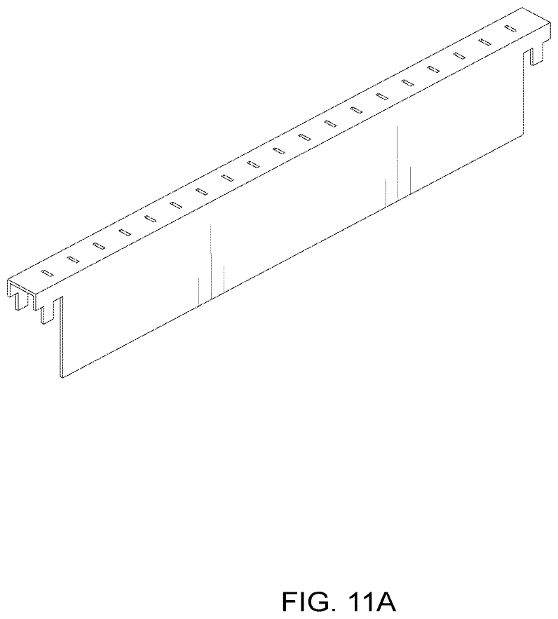

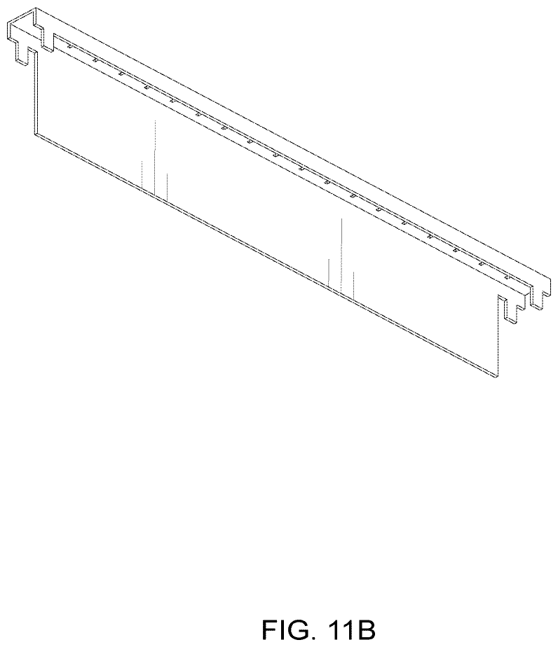

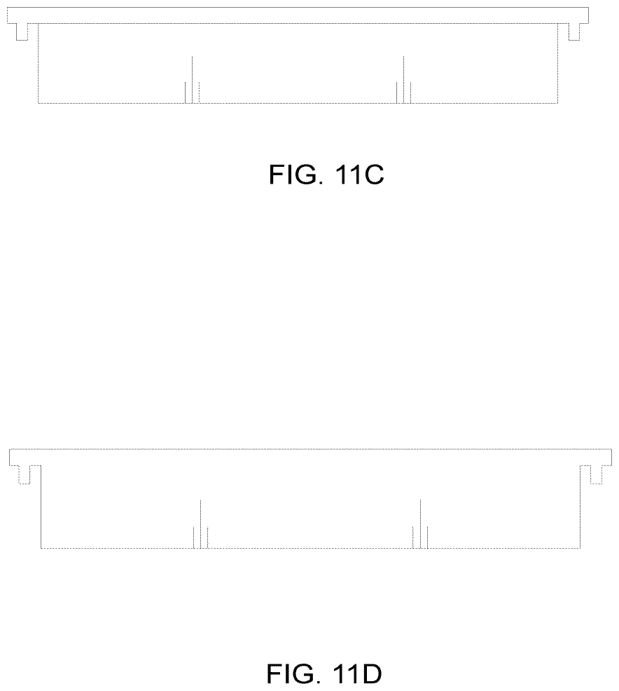

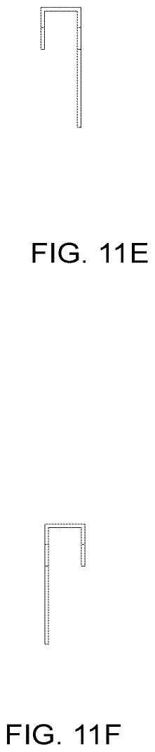

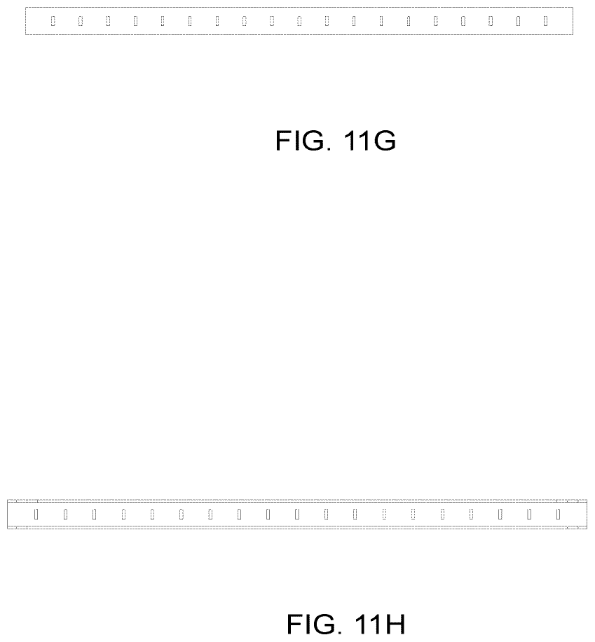

FIG. 11A is a top perspective view of the detachable short barrier;

FIG. 11B is a bottom perspective view of the detachable short barrier;

FIG. 11C is a side view of the detachable short barrier;

FIG. 11D is a side view of the detachable short barrier;

FIG. 11E is a front view of the detachable short barrier;

FIG. 11F is a rear view of the detachable short barrier shown in FIG. 11A;

FIG. 11G is a top view of the detachable short barrier;

FIG. 11H is a bottom view of the detachable short barrier;

FIG. 11I is a side view of the metal detachable short barrier showing the other side that is not shown in FIG. 11A.

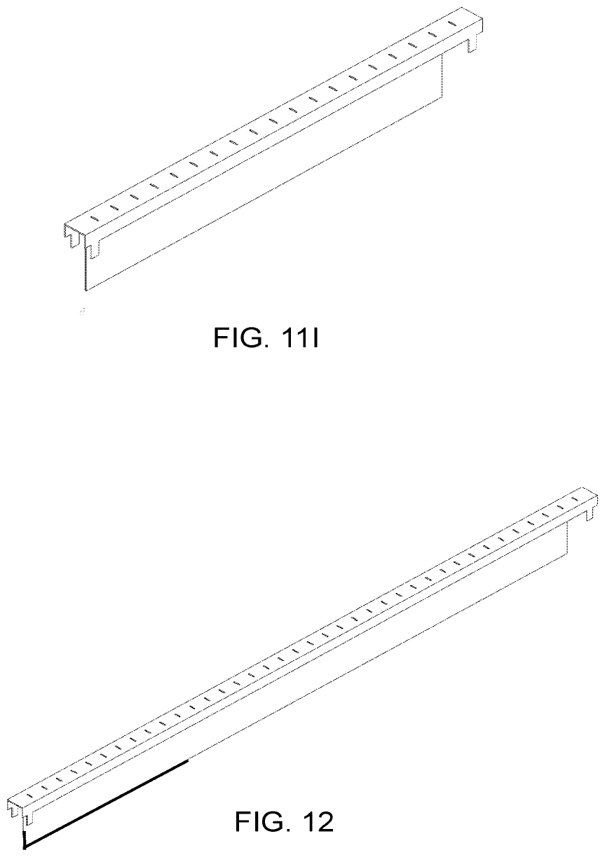

FIG. 12 is a perspective view of a metal detachable long barrier; which is an elongated version of the metal detachable short barrier show in the FIG. 11 series such that the central portion is longer.

FIG. 13A is a perspective view of a concrete-casting mold system having a detachable long barrier in an attached position therein coupled to a metal concrete-casting mold;

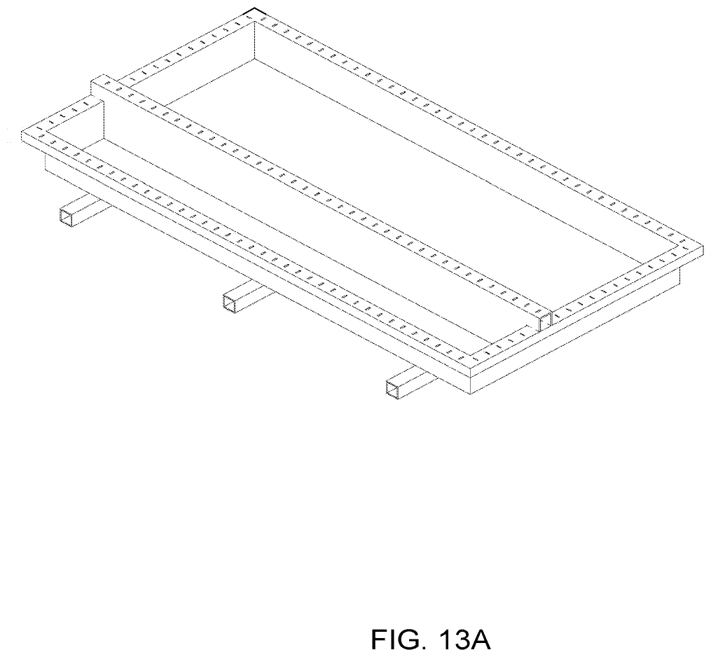

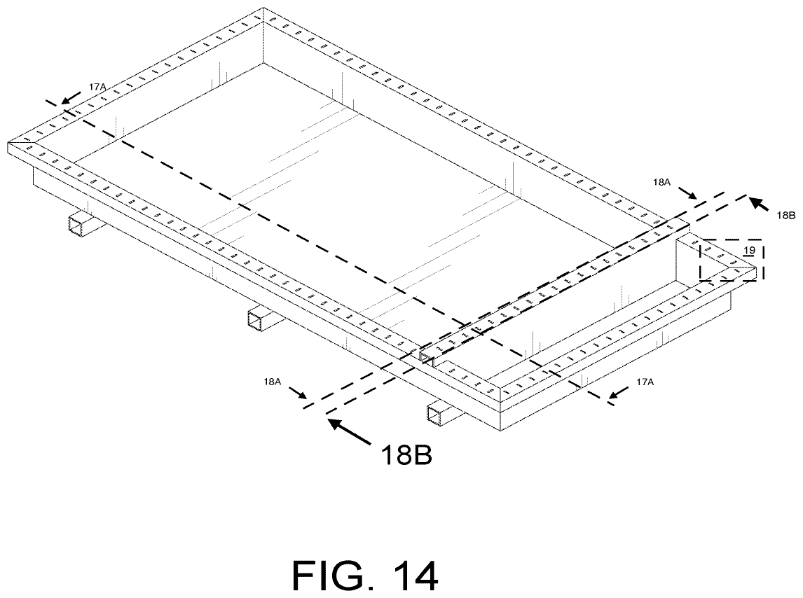

FIG. 14 is a perspective view of a concrete-casting mold system having a detachable short barrier in an attached position therein coupled to a metal concrete-casting mold;

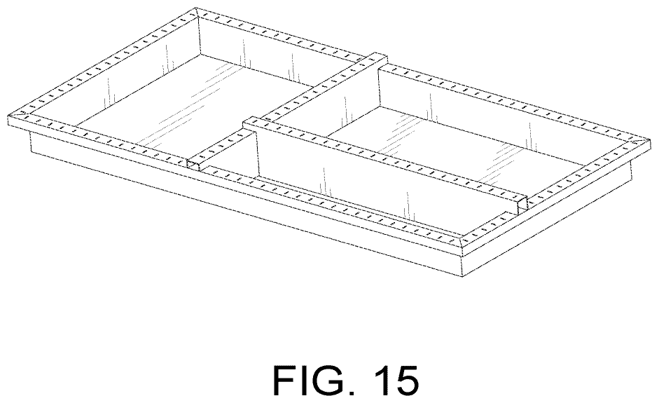

FIG. 15 is a perspective view of an embodiment of a concrete-casting mold for forming at least one concrete slab of a concrete-casting mold system, the metal mold having a plurality of detachable barriers wherein a short detachable barrier wall is coupled to a second wall and a fourth wall of the metal mold, wherein a medium-length detachable barrier wall is coupled to both the short detachable barrier wall and a third wall of the metal mold.

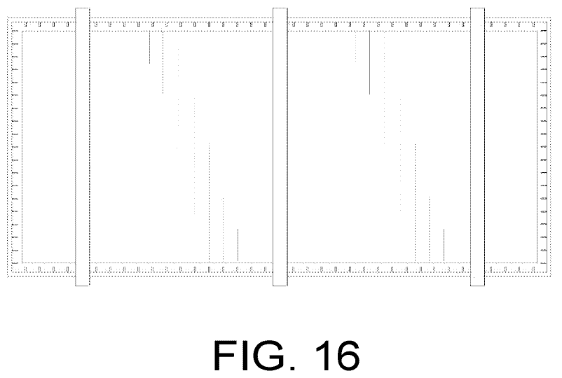

FIG. 16 is a bottom view of a metal concrete casting mold;

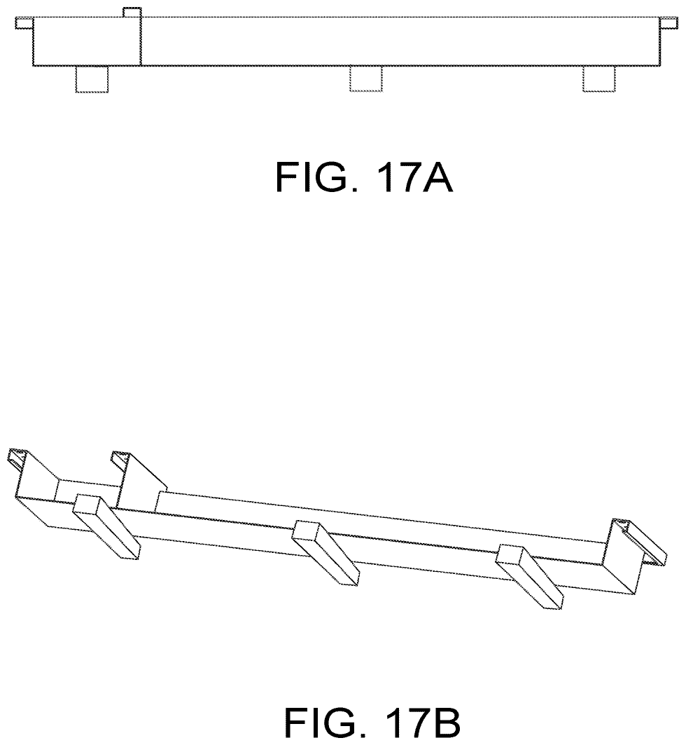

FIG. 17A is a cross sectional view of a concrete-casting mold system;

FIG. 17B is a cross sectional perspective view of the concrete-casting mold system depicted in FIG. 17A;

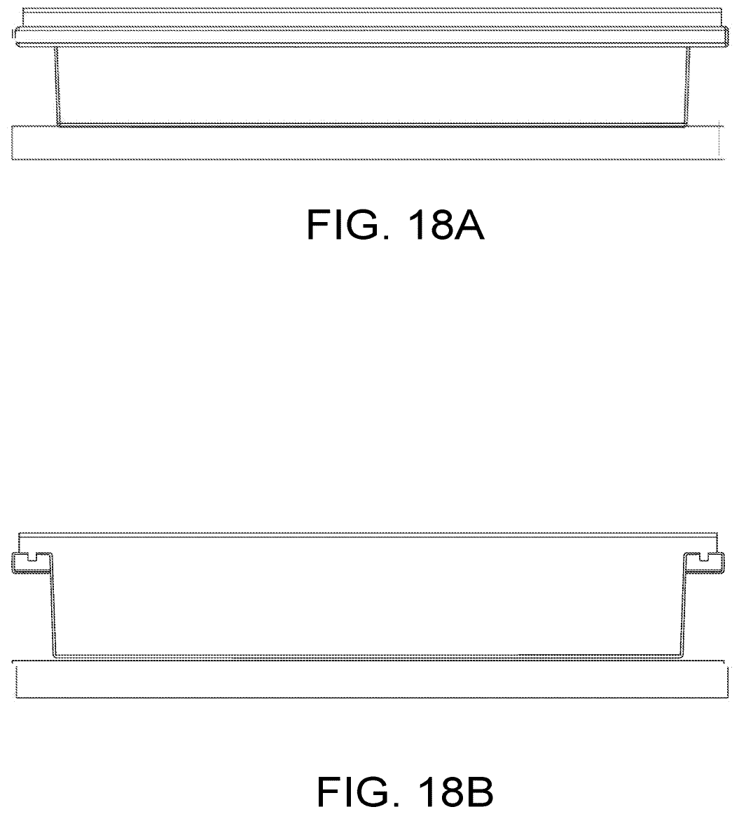

FIG. 18A is a cross sectional side view of the concrete-casting mold system depicted in FIG. 14;

FIG. 18B is a cross sectional side view of the concrete-casting mold system depicted in FIG. 14;

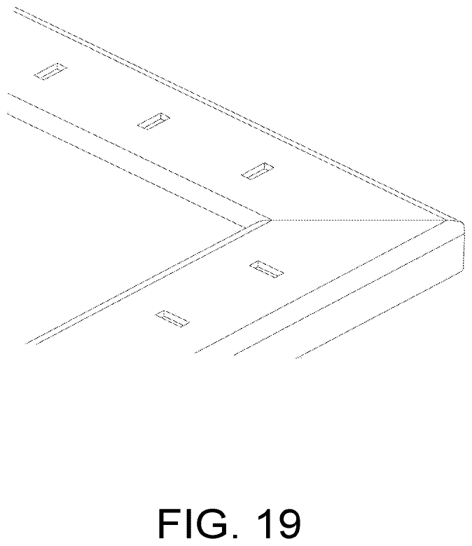

FIG. 19 is an enlarged view of a corner of the mold shown in FIG. 14;

FIG. 20 depict an alternative embodiment of a non-metal mold wherein a headstone has been placed facedown against the upper surface of the base of the non-metal mold; FIG. 20 also depicts a step of a method for casting a concrete slab, namely, inserting and sealing a headstone to the bottom of a plastic form before pouring concrete over it;

FIG. 21 shows a step of a method for forming a concrete slab wherein lifting members have been inserted into inserted into a layer of wet concrete as well as a vase accessory, in which a cylindrical element and a sleeve surrounding the cylindrical element wherein the cylindrical element and the sleeve surrounding the cylindrical element had been inserted into concrete poured into a plastic mold.

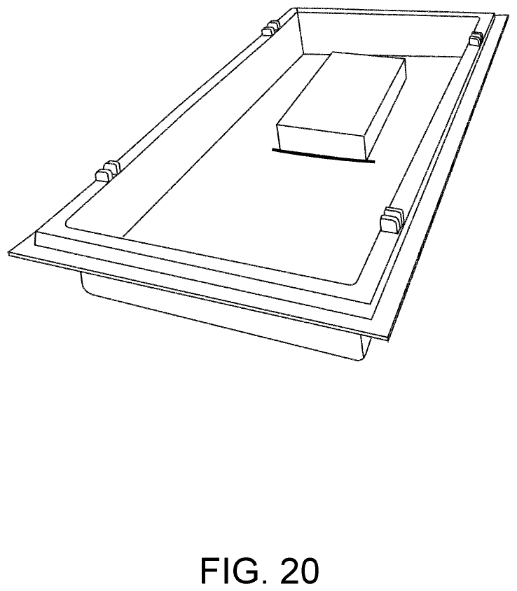

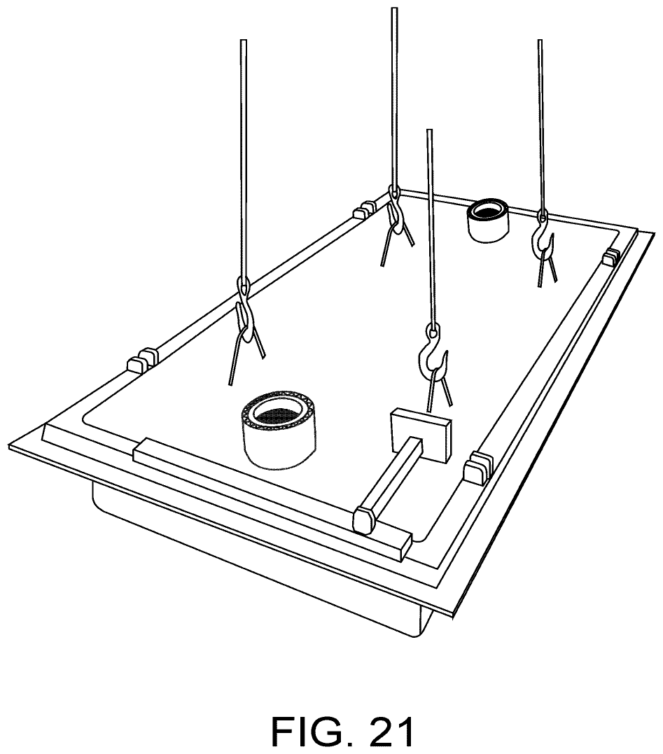

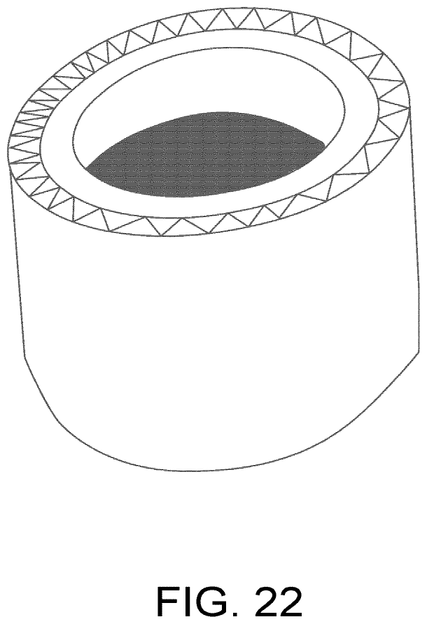

FIG. 22 shows an enlarged view of a cylindrical element disposed in a liner;

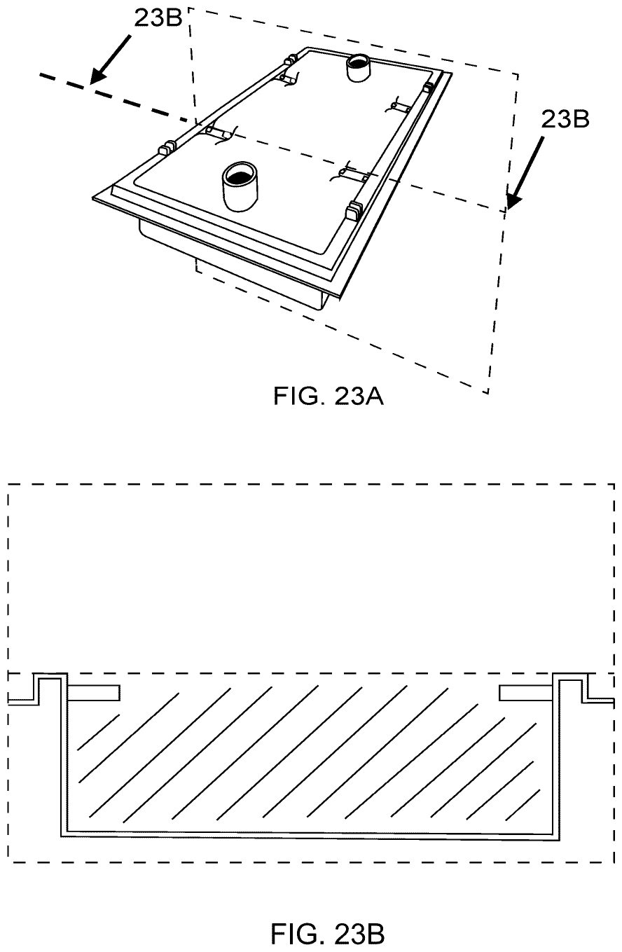

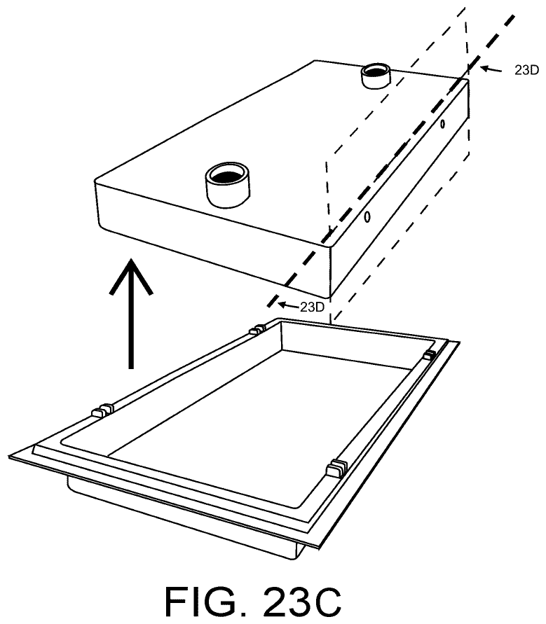

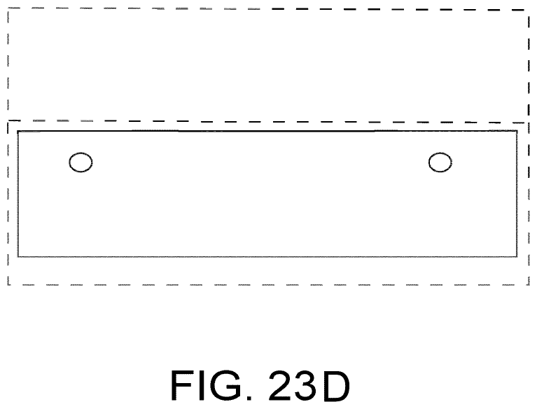

FIG. 23A depicts an embodiment of a casting mold filled with drying concrete that may be used in a method step of using a mold to cast concrete in which a user is inserting cylindrical objects flush with the wall of an embodiment of a plastic mold to create anchor points for a finished solidified concrete slab; two reference arrows referring to FIG. 23B are shown.

FIG. 23B is a schematic depicting a cross-sectional view of the mold where in a pair of cylindrical object have been inserted into wet concrete;

A description of FIG. 23C is shown in the next paragraph.

FIG. 23C depicts an embodiment of a concrete slab that has been removed from a plastic mold that may be used in a method step related to FIG. 23A and FIG. 23B, wherein the pair of cylindrical objects have been submerged below the top layer of the concrete, wherein the step of removing the concrete slab from the plastic mold has been shown;

FIG. 23D shows a cross-sectional view of a concrete slab having a pair of cylindrical objects inserts, in some embodiments the cylindrical objects each have internal threads thus being configured to be threadedly coupled to a grippable bar having an elongated threaded portion (see FIG. 23C for reference arrows showing the cross-sectional plane);

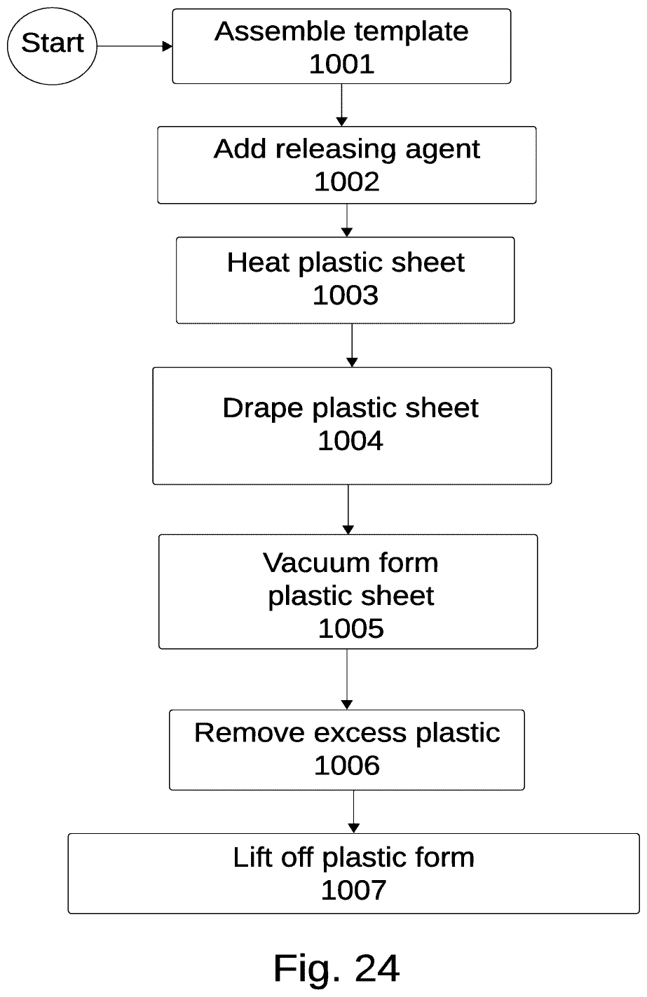

FIG. 24 depicts a method for forming a plastic mold for concrete-casting;

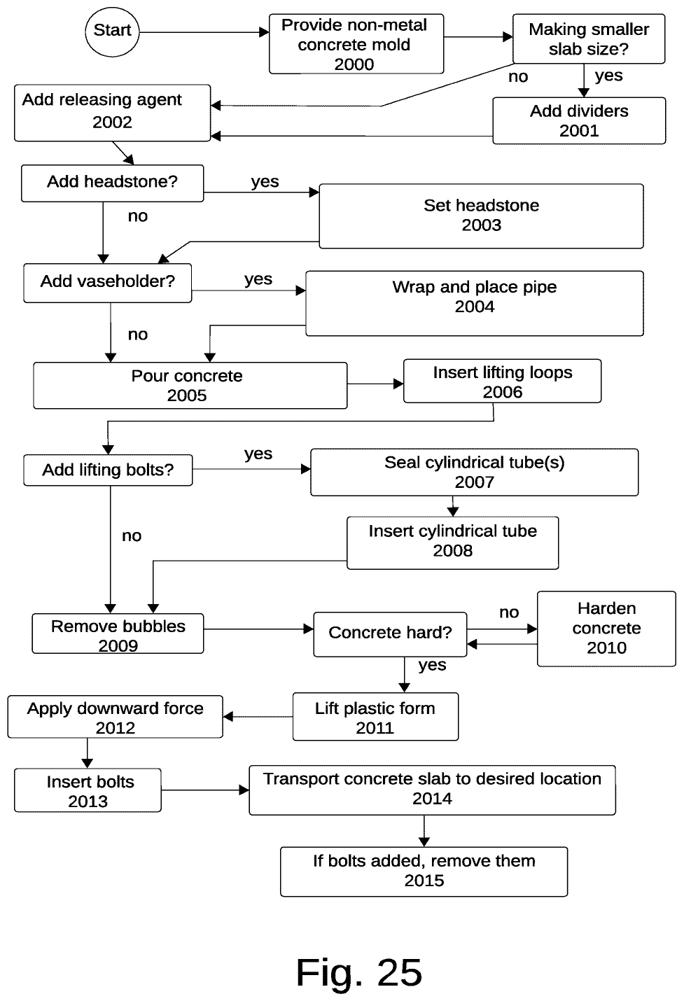

FIG. 25 depicts a flowchart depicting a method of using a non-metal concrete-casting mold;

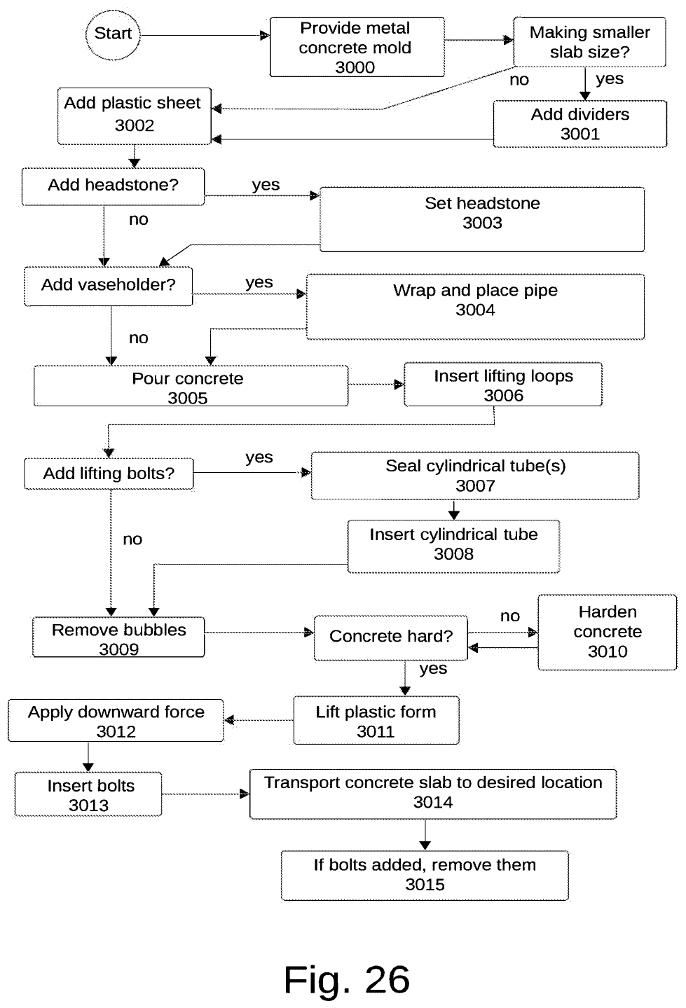

FIG. 26 depicts a flowchart depicting a method of using a metal concrete-casting mold.

### DETAILED DESCRIPTION

It will be readily understood that the components of the present invention, as generally described with reference to the drawings herein, could be implemented in a wide variety of different configurations. Thus, the following more detailed description of the embodiments of the system and method of the present invention, is not intended to limit the scope of the invention, but is merely representative of various embodiments of the invention. Unless explicitly stated, the use of “or” means and/or, that is, this is the non-exclusive meaning of or.

Referring to FIG. 1, the concave grooves in template form may have shoulder as shown in Figures showing non-metal molds, such as FIG. 6. Additionally, other shapes than concave grooves are contemplated. In FIG. 1, an embodiment of a template form, for making a plastic mold, mold assembly 100 is shown, depicting a base 110, a left wall 210, a top wall 220, a right wall 230, a bottom wall 240, and a floor 250. A divider slot 200a is also shown, which may be about 8.5 inches from the nearest corner. The divider slot may be a curved portion, and the curved portion may be flanked by one or more flanges. The walls, and wall grooves, and base of the template form are substantially similar to the corresponding parts of the walls, wall grooves, and base of non-metal mold and corresponding descriptions may be applied to both. The primary difference between the template form and the non-metal mold is that in preferred embodiments, the template form has a secondary base coupled to the base wherein the secondary base extends beyond the base and has cross-members having at least one hole, disposed inside the secondary base, and supporting the base,

In preferred embodiments, the divider slot 200a may be between 7 inches and 9 inches from the nearest corner. In some preferred embodiments, the walls 210, 220, 230, 240 and floor 250 may be undetachably coupled to the base 110 such that the walls 210, 220, 230, 240 and floor 250 are supported by the base 110. The walls may also have any number of divider slots disposed at any location, including but not limited to, the top wall 210, left wall 220, right wall 230, and bottom wall 240, such that a dividing element could be inserted into any of the divider slots and detachably coupled to the walls. The inside surfaces of the walls may also be disposed of at an angle wider than 90 degrees to the floor to allow easier removal of a concrete slab. This assembly comprises a template form 100 and may or may not have one or more dividing elements inserted into it.

Referring to FIG. 1, in some preferred embodiments, a divider slot may be a concave semicircular cutout or indentation on the top edge or surface of the walls, such that the cutout or indentation extends the width of the wall, the axis of said semicircular cutout or indentation being substantially perpendicular to the length of the wall.

Some embodiments of the divider slot may be a vertical hole or thin cutout slot that goes through the top edge of the walls. The long side of the profiles of these cutouts may also be substantially perpendicular to the length of the walls.

Referring now to FIG. 1, In some embodiments, the distance from divider slot 200g to the nearest corner on the same wall is 36 inches; in some embodiments, the distance from divider slot 200g to divider slot 200h is 12 inches; in some embodiments, the distance from divider slot 200h to divider slot 200i is 12 inches; in some embodiments, the distance from divider slot 200i to divider slot 200j is 12 inches; in some embodiments, the distance from divider slot 200j to the corner is 12 inches.

Referring to FIG. 2A, a cross-section view of the base 110 is shown, perpendicular to the cross-sectional view of the base 110 shown in FIG. 5. Shown in FIG. 4 is the inside of the base 110 of the concrete template form 100, also depicting vacuum air holes that extend through each of the supporting members such that a vacuum apparatus may be coupled to the plastic template form 100 such that air can be sucked, vacuumed, or moved through the base 110. The template form 100 may be assembled such that hot malleable plastic can be placed on top of the template form 100 and air may be sucked out of the template form 100 to allow the hot plastic to assume the shape of the template form 100 and solidify as it cools. In preferred embodiments, this solidified plastic coupled with the original template form 100 can be described as a plastic form and may have concrete poured directly into it and may be reused after the solidified concrete is removed. After the plastic has been molded and is solidified into a plastic form, a detachable wall may also be inserted into desired divider slots to change and/or divide the area and/or size of the form such that the size and area of any subsequent concrete poured may change in size and/or area defined by where the detachable wall or walls are placed. The detachable wall or walls may be moved into any position during any instance of the use of the form. If arranged properly, divider walls may be configured to allow multiple slabs of different dimensions to be poured and solidified all within one form.

Referring to FIG. 6, an illustration is shown of a concrete-casting mold system 99 in accordance with various aspects and embodiments of the subject disclosure. In one or more embodiments, concrete-casting mold system 99 has at least one concrete-casting mold 301. The at least one concrete-casting mold 301 may have a base 318. The bottom of a concrete-casting mold 301 may be 36 inches in width and the top of the mold may be wider; for example, in some preferred embodiments the top of the mold is 36 inches and ¾ of an inch or 36 inches and ⅝ of an inch; this disclosure contemplates a change in a corresponding dimension of plus or minus 5 percent, and in some preferred embodiments the difference in the dimensions at the top of the mold are substantially 2% greater than the corresponding dimension at the bottom of the mold.

Referring to FIG. 4a, various dimensions may be used, including dimensions for the positioning of the slots. Also, each wall of the concrete mold may have at least one slot such that an end portion of a dividing element may be disposed in the at least one slot. In some embodiments, the at least one slots may be arranged to hold at least one long dividing element or at least one short dividing element. In the preferred embodiments, a slot on a wall may be aligned with a slot on the opposing wall such that a dividing element may be disposed into the concrete mold and between the opposing walls such that a distal end of a dividing element may be disposed into a slot of a first wall and a proximal end of a dividing element may be disposed into a slot on a second wall.

Referring to FIG. 6 as well as FIG. 10B, a concrete-casting mold system 99 may comprise
a concrete-casting mold 301, the concrete-casting mold 301 may comprise:
a base 318 (4a) may comprise an upper smooth flat surface 326 (4a),
   a plurality of walls 311 (4a), the plurality of walls 311 may comprise
   a first sloped wall 310 which may comprise
   a major upper length element 310a;
   a second sloped wall 312 adjacent to the first sloped wall 310, the second sloped wall 312 may comprise a major upper length element 312b;
   a third sloped wall 314 opposing the first sloped wall 310, the third sloped wall 314 may comprise a major upper length element 314a;
   a fourth sloped wall 316 opposing the second sloped wall 312, the fourth sloped wall 316 may comprise a major upper length element 316a, wherein the first sloped wall 310, the second sloped wall 312, the third sloped wall 314, and the fourth sloped wall 316 may each be undetachably coupled to the base 318;
      wherein the plurality of walls 311 and the base 318 collectively may define an internal cavity 328 (see FIG. 4a where there are no detachable barrier walls) having a height equal to at least 6 inches, the internal cavity 328 may comprise
      a lower internal perimeter 320 being substantially 36 inches by substantially 80 inches; and,
      an upper internal perimeter 322 being substantially 30.6 inches by substantially 81.6 inches.

Referring to FIG. 10A, for metal molds, notch pairs may be substantially spaced at regular intervals along all of the upper edges of the walls so as to receive at lease one pair of prongs; there may be substantially two inches between the two notches of a notch pair and substantially two inches from the other notch pair; the notch pairs may receive or stabilize a pair of prongs of a barrier wall.

Referring to FIG. 10B, an embodiment of a concrete-casting mold system having a mold 99 is shown, depicting a floor, walls, divider slots (also referred to as a plurality of wall grooves), and a divider wall. The walls and floor of the metal form may all be one solid sheet of metal that has been folded to form the metal mold 100. Any number of divider slots may be cut into any of the walls of the metal template form 100 such that a detachable wall may be inserted into the divider slots and detachably coupled to the walls.

Referring to FIG. 11B, an embodiment of a detachable barrier wall, depicting overhanging flanges parallel and in line with the top edge of the detachable wall undetectably coupled to the short edges of the divider wall. Some preferred embodiments of the detachable wall may also have pins or further extrusions normal to and on the underside of the flange that may be fit or inserted into divider slots such that the detachable wall spans the length or width of a template form 100. Some preferred embodiments of the detachable wall may also have divider slots disposed on the top edge of the detachable wall such that separate divider walls may also be inserted and detachably coupled perpendicular to divider walls already inserted into a mold. A first flange, the first flange comprising a first prong 400 and a second prong 402, are shown.

Referring to FIG. 14, dividers, which may be a dividing element that may be used as a dam, may also have at least one slot embedded into the body of a horizontally-positioned dividing element such that at least one vertically-positioned dividing element having at least one prong at the end may rest on top of the vertically positioned dividing element, wherein the at least one prong of the vertically-positioned dividing element may be detachably-disposed inside the at least one slot of the horizontally-positioned dividing element.

Referring to FIG. 15, dividers, which may be a dividing element that may be used as a dam, may also have at least one slot embedded into the body of a short barrier wall

Referring to FIG. 25, that is to the method depicted in FIG. 25, in the preferred embodiments, the non-metal mold is a plastic mold or a plastic composite mold. A plastic liner may be placed against the upper surface of the base; in some preferred embodiments, the method of using the non-metal mold is free of the substep or step or placing a plastic liner.

Referring to FIG. 26, that is to the method depicted in FIG. 26, in the preferred embodiments, when using a metal mold, a user may add a plastic liner to the upper surface of the base, which may aid in creating a “finished look”.

The figure shows some exemplary dimensions and also some exemplary positions for slots; however, various other dimensions for the concrete molds as well as various positions for slots on the walls are contemplated.

Referring to FIG. 2B, a cross-section view of base 110 is shown, depicting 4 supporting members 120, 130, 140, and 150 disposed within base 110. In some preferred embodiments, these supporting members may be undetachable and coupled to the inside of the base such that they provide structural support to the base.

Referring to FIG. 10B, when the metal template form 100 is assembled and folded to a desirable shape, a premade plastic liner may be inserted into it. Assembly of the metal template form 100 with or without a plastic liner together may comprise a metal form. Concrete may be poured into this premade plastic liner and/or metal form and solidified into a desired shape or size. Divider walls may be added before pouring concrete to adjust the size and/or area of subsequent concrete slabs. Divider walls may be moved at any time to any desired position during any instance of the use of the form. The detachable wall or walls may be moved into any position during any instance of the use of the form. If arranged properly, divider walls may be configured to allow multiple slabs of different dimensions to be poured and solidified all within one form. (The plastic liner may be constructed such that it may also be reused more than once.)

Referring to FIG. 13, an embodiment showing a method of inserting objects, such as a premade headstone, into the form before pouring wet concrete is depicted. Objects that may be seen or accessed from the bottom side of the form or top side of the finished concrete slab may have their outward surface completely covered with masking tape or other tape or material and be placed into the form before pouring concrete and all edges of the object sealed to the bottom of the form using a sealant such as caulk to prevent wet concrete from penetrating underneath the object and marring its surface. After the concrete has dried and solidified, these objects will remain fixed inside the finished concrete slab.

Referring to FIG. 14, a depiction is shown of a method for inserting removable objects into the form and resulting concrete slab. Some concrete slabs may require round holes or other cavities inside the finished slab. A user may place and hold firmly an object, such as a PVC pipe, into the form while concrete is poured into it. After the concrete is solidified, the object may be removed, creating a cavity in the shape of the removed object.

Referring to FIG. 15, a depiction of a method for removing and transporting a solidified concrete slab from a form. This method may include inserting rings or similarly shaped objects into the top of previously poured wet concrete. After the concrete has dried and solidified, the rings may be used to lift the concrete slab such that it may be removed from the form and/or transported elsewhere.

Referring to FIG. 16, a depiction of a method for removing and transporting a solidified concrete slab from a form. This method may include inserting one or more cylindrical objects into previously poured wet concrete. By taping closed the open faces of the cylindrical object, and inserting them such that the taped face lies flush with the side of the form and completely covered by the wet concrete after the concrete has solidified and dried, the tape may be removed, and the object be used as an anchor point to lift the concrete slab such that it may be removed from the form and/or transported elsewhere.

In some embodiments various types of materials may be added into the concrete mix before it has fully been set or cured; some examples of these materials are fibers.

In some embodiments, a recess may be formed by affixing a body, such as a foam body or wood body, to the base of the forms; then after pouring concrete into the form and curing the concrete, after removing the concrete from the form and inverting the concrete, the newly-formed concrete slab may have a depression. The depression may be useful for setting a headstone partially into the concrete slab or for mounting the headstone in the depression at an angle.

At times, a dowel or puff of air may be used to remove objects.

An object such as a foam cylinder, which may be made from PVC pipes, surrounded with a liner may be attached to the base of the concrete to form a depression in poured concrete; the depression may be suitable for holding a flower vase.

In some preferred embodiments, the edges of the form are rounded so as to form a concrete slab having rounded edges.

In some preferred embodiments, the angle of a wall of the concrete mold and the floor is 7%, is greater than 0.1 degrees and 90 degrees, is between 3 degrees and 15 degrees, or is between 4 degrees and 10 degrees.

In the preferred embodiments, corners and edges of the mold may be rounded, which may be used to create a smoother edge or to prevent chipping of the concrete slab.

In some embodiments, the concrete mold is placed on top of a concrete board, and the concrete board is placed on top of a pallet before concrete is poured into the mold.

Grout, epoxy, or other affixing agents may be used to affix objects to the concrete molds. Some portions of the concrete mold or objects that are attached to the concrete mold may have the dimensions of 8 inches by 16 inches.

The bottom dimensions of the mold may be 36″×80″×6″, wherein the upper dimensions of the mold, that is the space in which concrete will be poured, may be between 0.001% and 5 percent greater. The following ratios may be applied to the other length and the height; for example, when the bottom width dimensions is 36 inches, then the upper width dimension that corresponds to the bottom width dimension may be between 36 inches and ¾ inch and 36 inches and ⅝ inches.

A recess disposed along the major upper length element of a sloped wall may be flanked on both sides by a shoulder element, which is shown in the depictions of the non-metal mold herein; even though the template mold (see FIG. 1) depicts concave grooves it should be noted that in the preferred embodiments each concave groove is flanked by a shoulder element so as to be configured to be useful for forming the recess flanked by two shoulder elements that are shown in the figures of the non-metal mold.

The term “wall groove” refers to a recessed portion of a wall that is flanked by two shoulder elements that is disposed along the major length of a wall of a mold that is configured for cradling a portion of a barrier wall that may be detachably disposed on the upper portion of the recessed portion of the wall; in the preferred elements the two shoulder elements rise above the wall; however, in some embodiments the two shoulder elements are embedded into the wall and the top portion of the should elements is flush with the major length of the wall.

In general, a pair of wall grooves, which may comprise a first wall groove and a second wall groove, may be embedded into the mold such that a first wall groove of a first wall may be positioned opposite to a second wall having a second wall groove, such that the each of the wall grooves of a pair of wall grooves may be configured to cradle a portion of a barrier wall such that the barrier wall may be sufficiently stabilized to act as a barrier to poured wet concrete. The location of the pairs of wall groove may be such in the preferred embodiments such that a user may decide where to place a barrier wall thereby determining the size of concrete slab that may be formed by pouring concrete into a space defined by the barrier wall and the edge of the mold. In some embodiments, a barrier wall is used to compartmentalize a mold into two or more compartments allow you to put a divider in it and choose how big you want your concrete pad to be. The wall grooves may be located on the longer walls of a mold at or substantially at a 36″ mark, 48″ mark, 60″ mark, and the 72″ mark. On the width sides the wall grooves may be located at the 30″ mark. By having wall grooves in the above-mentioned locations, then a user may form the following sized concrete slabs using the barrier wall inserted into a mold. It is contemplated that various heights of the concrete may be formed, and even though the chart below lists out the height as 6 inches, this disclosure contemplates varying heights raging from ¼ inch to 6 inches and ½ inches:

| | |
|---|---|
| 30″ × 80″ × 6″ | 36″ × 80″ × 6″ |
| 30″ × 72″ × 6″ | 36″ × 72″ × 6″ |
| 30″ × 60″ × 6″ | 36″ × 60″ × 6″ |
| 30″ × 48″ × 6″ | 36″ × 48″ × 6″ |
| 30″ × 36″ × 6″ | 36″ × 36″ × 6″ |
| 30″ × 80″ × 4″ | 36″ × 80″ × 6″ |
| 30″ × 72″ × 6″ | 36″ × 72″ × 6″ |
| 30″ × 60″ × 6″ | 36″ × 60″ × 6″ |
| 30″ × 48″ × 6″ | 36″ × 48″ × 6″ |
| 30″ × 36″ × 6″ | 36″ × 36″ × 6″ |

After selecting a metal mold or a non-metal mold, in some preferred embodiments a user may apply a releasing agent onto the surface of the mold or onto the surface of the plastic liner that contacts wet concrete when concrete has been poured into the form. A releasing agent, such as a solvent, may be sprayed when in liquid form or it may be applied when in powder form. In some embodiments, a user may then wipe dry the surfaces for which the releasing agent came in contact. A user may then attach a detachable barrier wall into the mold by placing one end of the barrier into a wall groove and then by placing the other end of the barrier into a wall groove that is on an opposing wall. The user may place the one or more dividers in such a location as to create one or more compartments for forming one or more concrete slabs of specific dimensions. With the ability to have multiple wall grooves and dividers the user may create multiple concrete slabs at the same time with just one form. The fourth step varies depending on if a user is doing just a concrete pad or putting in a headstone marker. If doing just concrete with nothing else in it, the user may add in your concrete to your desired amount. A user may use a lower amperage concrete vibrator to vibrate all the bubbles out. A user may also pat the concrete down with a trowel and repeating those steps of removing bubbles and patting down the concrete.

If adding a stone in the next step, a user may add tape to the face of the stone covering designs and lettering. Then before pouring concrete, a user may center the headstone upside down in-between the measurements to ensure appropriate mow strip regulations are met. Once the stone is in place in the form, a user may add a line of caulk around the face of the stone sealing it to the bottom of the form. Once caulking has dried, poured wet concrete may be added. The steps of a normal pad for removing bubbles or patting down the surface of the concrete may be applied. A user may add hooks, a lifting device, manhole cover rotators or other accessories and then wait for the concrete to dry. A user may use the hooks or the lifting device to provide a gripping surface useful for removing the concrete from the mold and then flipping the concrete slab 180 degrees so the portion that was flush against the base of the mold or against a plastic liner that was placed against the mold is now the visible portion viewable to those looking at the concrete slab that has been installed in a cemetery plot. The manhole rotators are also an option for a user rotating the slab, or in some embodiments, a user uses straps to rotate the concrete slab. Once flipped and the headstone is facing the right direction, a user may remove the tape with a scraper and also remove any excess caulk on the stone. If the concrete was vibrated poorly, a user will notice little pin holes, and a user may remove the pinholes by applying a mixture of powder and water you will then need to get a little mixture of powder and water to fill in the holes with it.

When the concrete pad a user may take a cylindrical element, such as PVC pipe that has a greater diameter then the vase. The user may then cut the cylindrical element to a desire height such as 8 inches to 10 inches tall. The user may secure the cylindrical element with tape or other elements or may physically hold the cylindrical element in a fixed location against the base of the mold, and then the user or a different user may pour concrete into the mold and around the cylindrical element. When the concrete is dry, a user may remove the cylindrical element; in some embodiments, a liner is applied to the outside surface of the cylindrical element before the concrete has been poured such that the concrete dries while contacting the liner, which may facilitate the removal of the cylindrical element.

The template form may be made from various materials including wood, light grade plastics, high grade plastics and composites.

Some preferred embodiments of the mold use metal, which can withstand the weight of the concrete and not bend as easily. With doing so the concrete may take exact measurements and mold of the metal form. (Recess also called wall groove) Various embodiments are disclosed:

Embodiment A1. A concrete-casting mold system 99 comprising
a concrete-casting mold 301, the concrete-casting mold 301 comprising
a base 318 (4a) comprising an upper smooth flat surface 326 (4a),
a plurality of walls 311 (4a), the plurality of walls 311 comprising
   a first sloped wall 310 comprising a major upper length element 310a;
   a second sloped wall 312 adjacent to the first sloped wall 310, the second sloped wall 312 comprising a major upper length element 312b;
   a third sloped wall 314 opposing the first sloped wall 310, the third sloped wall 314 comprising a major upper length element 314a;
   a fourth sloped wall 316 opposing the second sloped wall 312, the fourth sloped wall 316 comprising a major upper length element 316a, wherein the first sloped wall 310, the second sloped wall 312, the third sloped wall 314, and the fourth sloped wall 316 are each undetachably coupled to the base 318;
      wherein the plurality of walls 311 and the base 318 collectively define an internal cavity 328 having a height equal to at least 6 inches, the internal cavity 328 comprising
      a lower internal perimeter 320 being substantially 36 inches by substantially 80 inches; and,
      an upper internal perimeter 322 being substantially 30.6 inches by substantially 81.6 inches.

Additional embodiments are disclosed:

Embodiment A2. See FIG. 4A, where recess pairs are formed on two opposing walls so where it says a recess pair of the second sloped wall then that means the combination of the second sloped wall and the fourth sloped wall, the concrete-casting mold system 99 of embodiment 1, wherein the concrete-casting mold 301 comprises plastic material or plastic-composite material, wherein the second sloped wall 312 in conjunction with the fourth sloped wall further comprises a first recess pair comprising
a first recess and a second recess, wherein the first recess 500 is disposed along the major upper length element of the second sloped wall 312, the first recess directly opposing the second recess 502 disposed along the major upper length element of the fourth sloped wall 316.

Embodiment A3. The concrete-casting mold system 99 of Embodiment A2, wherein the second sloped wall 312 further comprises a second recess pair comprising
a third recess and a fourth recess, wherein the third recess 504 is disposed along the major upper length element of the second sloped wall 312, the third recess directly opposing a fourth recess 506 disposed along the major upper length element of the fourth sloped wall 316;
wherein the second sloped wall 312 further comprises a third recess pair comprising
a fifth recess 508 and a sixth recess 510, wherein the fifth recess is disposed along the major upper length element of the second sloped wall 312, the fifth recess directly opposing a sixth recess disposed along the major upper length element of the fourth sloped wall 316;
wherein the second sloped wall 312 further comprises a fourth recess pair comprising a seventh recess 512 disposed along the major upper length element of the second sloped wall 312, the seventh recess directly opposing an eighth 514 recess disposed along the major upper length element of the fourth sloped wall;
wherein a detachable barrier wall further comprises a first elongated flange and second elongated flange, wherein the detachable barrier wall is coupled via the first elongated flange and the second elongated flange to one of the recess pairs.

Embodiment A4. (for the long divider) The concrete-casting mold system 99 of embodiment 3, wherein the first sloped wall 310 in conjunction with the third sloped wall further comprises
a fifth recess pair comprising
a ninth recess 516 and a tenth recess 518, wherein the ninth recess is disposed along the major upper length element of the first sloped wall 310, wherein the tenth recess is disposed along the major upper length element of the third sloped wall 314.

5. (pinpoint the dogears for combo) The concrete-casting mold system 99 of Embodiment A4 wherein the (measured from the inner wall) first recess pair is located at a location between 34.2 inches 37.8 inches from the first wall, wherein the second recess pair is located at a location between 45.6 inches and 50.4 inches from the first wall, wherein the third recess pair is located at a location between 57 inches and 63 inches from the first wall, wherein the fourth recess pair is located at a location between 68.4 inches and 75.6 inches from the first wall, wherein the fifth recess pair is located at a location between 28.5 inches and 31.5 inches from a point of intersection between the second sloped wall 312 and the third sloped wall 314.

Embodiment A6. The concrete-casting mold system 99 of embodiment A1, wherein the concrete-casting mold 301 is a metal mold 325.

Embodiment A7. The concrete-casting mold system 99 of embodiment A6, wherein the major upper length element of the first sloped wall 310 further comprises at least one notch pair, wherein the major upper length element of the third sloped wall 310 further comprises at least one notch pair, wherein the major upper length element of the second sloped wall 312 further comprises at least one notch pair, wherein the major upper length element of the fourth sloped wall 316 further comprises at least one notch pair (explain what is a notch pair).

Embodiment A8. The concrete-casting mold system 99 of embodiment A6, wherein the major upper length element of the first sloped wall 310 further comprises at least three notch pairs, wherein the major upper length element of the third sloped wall 310 further comprises at least three notch pairs, wherein the major upper length element of the second sloped wall 312 further comprises at least three notch pairs, wherein the major upper length element of the fourth sloped wall 316 further comprises at least three notch pairs (explain what is a notch pair).

Embodiment A9. The concrete-casting mold system 99 of embodiment A8, further comprising
a short detachable barrier wall comprising
   a first flange, the first flange comprising a first prong 400 and a second prong 402, the first prong and the second prong being inserted into a notch pair of the at least two notch pairs of the second sloped wall 312 so as to stabilize the short detachable barrier;
   a second flange, the second flange comprising a third prong and a fourth prong, the third prong and the fourth prong being inserted into a notch pair of the at least two notch pairs of the fourth sloped wall 316 so as to stabilize the short detachable barrier.

Embodiment A10. The concrete-casting mold system 99 of embodiment A8, further comprising
a long detachable barrier wall comprising
   a third flange, the third flange comprising a fifth prong and a sixth prong, the fifth prong and the sixth prong being inserted into a notch pair of the at least one notch pair of the first sloped wall 310 so as to stabilize the long detachable barrier;
   a fourth flange, the fourth flange comprising a seventh prong and an eighth prong, the seventh prong and the eight prong being inserted into a notch pair of the at least six notch pairs of the fourth sloped wall 316.

Embodiment A11. (T-form) The concrete-casting mold system 99 of Embodiment A9, wherein the short detachable barrier wall comprises a major upper length element, wherein at least one notch pair is disposed along the major upper length element of the short detachable barrier, wherein the concrete-casting mold system 99 of embodiment A9 further comprises a
a medium-length detachable barrier wall comprising,
a fifth flange, the fifth flange comprising a ninth prong and a tenth prong, the ninth prong and the tenth prong being inserted into the at least one notch pair disposed along the major upper length element of the short detachable barrier wall,
a sixth flange, the sixth flange comprising an eleventh prong and a twelfth prong, the eleventh prong and the twelfth prong being inserted into a notch pair of the at least six notch pairs of the fourth sloped wall 316.

Embodiment A12. further comprising a plurality of parallel support bars coupled to the base.

Embodiment A13. A method of creating a plastic mold from a template form comprising
Providing a template form similar to embodiment A1, wherein the base further comprises a second base, wherein disposed within the secondary base are at least three support members, wherein the at least three support members each comprises at least one void area.
Disposing a sheet of plastic over the template form
Vacuuming the sheet of plastic
Removing the form

Embodiment A14.
Method of using a plastic mold/providing a plastic mold/applying a releasing agent adding a headstone, pouring concrete, adding at least one lifting accessory, work out air bubbles/waiting a period of time, removing slabs by lifting the concrete slab via the lifting accessory.

Embodiment A15 like 10 but adding at least one divider (may pour into al of the areas separated by the dividers.)

Embodiment A16. Adding at least one accessory: headstone, vase holder, line holder, removable horizontally aligned bolt (taping).

Embodiment A17. Adding all of the following accessories: headstone, vase holder, line holder, removable horizontally aligned bolt (taping).

Embodiment A18. Method of using a metal mold; inserting a liner (plastic); applying a releasing agent; inserting at least one accessory selected from the group consisting of a headstone, vase holder, side bolt; pouring concrete.

Embodiment A19. Adding at least one accessory: headstone, vase holder, line holder, removable horizontally aligned bolt (taping).

Embodiment A20. Adding all of the following accessories: headstone, vase holder, line holder, removable horizontally aligned bolt (taping).

Embodiment A21. A method of using a plastic mold to form a concrete slab
providing a plastic mold (see above).

Embodiment A22. A method for molding concrete comprising:
providing a plastic mold (see above)
   inserting dividing walls into a concrete mold to form at least two compartments.
pouring concrete into two of the compartments;
   applying a releasing agent;
   inserting and caulking an inverted headstone to the upper surface of the base pouring concrete,
   creating an anchor point via submerging a threaded hollow tube, having ends covered, lush below the surface of the wet concrete but at least ¼ inch above the upper surface of the base;
adding lifting device;
   waiting for concrete to dry;
removing bubbles from the surface;
when the concrete is dry;
remove the concrete slab via the lifting device;
invert the concrete slab;
   against a wall of the plastic mold;
      inserting lifting devices and eliminating air bubbles; and,
      removing concrete once it has solidified.

Embodiment A23. The concrete mold of a previous embodiment, wherein corners and edges of the concrete mold are rounded.

Embodiment A24. A divider for a concrete mold comprising:
a body comprising:
a front side;
a back side;
a bottom portion;
a top portion;
wherein the top portion has an extended portion which extends beyond a width of the bottom portion on both ends of the divider;
the ends of the extended portion having one or more anchoring projections directed toward the bottom portion of the divider;
wherein the anchoring projections may be inserted into slots of a concrete mold or concrete mold divider;
a flange protruding perpendicularly from the top edge of the divider;
the flange having one or more slots allowing one edge of an insertable divider to be inserted therein.

Embodiment A23. The divider of a previously-disclosed embodiment, wherein a plurality of anchoring projections are on one side of the body of the divider.

Embodiment A24. The divider of a previously-disclosed embodiment, wherein a plurality of anchoring projections are on both sides of the body of the divider.

A method for molding concrete comprising:
inserting dividing walls into a concrete mold;
applying a releasing agent;
inserting and caulking surface accessories;
inserting lifting devices and eliminating air bubbles;
removing concrete once it has solidified.

The method of a previously disclosed embodiment, wherein the concrete mold is plastic that has been vacuumed into a shape of the mold.

The method of a previously disclosed embodiment, wherein the concrete mold is metal with an inserted plastic liner.

The method of a previously disclosed embodiment, wherein concrete is removed from the concrete mold with one or more rings being placed into the concrete before it has dried.

The method of a previously disclosed embodiment, wherein a cylinder may be attached to a base of a concrete form so as to form a depression in the concrete form.

Divider has at least 2 tabs-tabs is another term for prongs or anchoring projections in the context of a barrier wall.

Divider may have 3 tabs.

Divider have 4 tabs.

2 on each side.

Additional disclosures which may repeat numbering previously disclosed and the following references to embodiments refers to the following section beginning with the next sentence:

Embodiment 1. A metal concrete-casting mold system comprising:
a concrete-casting mold 301, the concrete-casting mold 301 comprising
a base 318 (4a) comprising an upper smooth flat surface 326 (4a),
   a first horizontally-aligned wall coupled to the base;
a second horizontally-aligned wall coupled to the base, the second horizontally-aligned wall opposing the first horizontally-aligned wall;
a first vertically-aligned wall coupled to the base;
a second vertically-aligned wall coupled to the base;
wherein a top edge of one or more walls contains one or more slots along a length the top edge;
the one or more slots allowing anchors of an insertable divider to be inserted therein, the insertable divider having a front portion, a back portion, a top edge, a left edge, a right edge, and a bottom edge;
wherein the insertable divider, when inserted into slots of opposing walls, subdivides the concrete mold into multiple compartments;
wherein the concrete mold is adaptable to accept a variety of configurations of one or more insertable dividers.

The concrete mold of embodiment 1, wherein the one or more slots are holes in a flange which extends perpendicularly from the top edge of one or more walls.

The concrete mold of embodiment 1, wherein the one or more slots are concave grooves in the top edge of one or more walls which extend a width of the wall.

The concrete mold of embodiment 1, wherein the one or more slots are between 7 and 9 inches from a nearest corner.

The concrete mold of embodiment 1, wherein a distance between the one or more slots and a nearest corner of the concrete mold is 36 inches.

The concrete mold of embodiment 1, wherein a distance between slots is 12 inches.

The concrete mold of embodiment 1, wherein the base, walls, and dividers are cut out of a sheet of metal.

The concrete mold of embodiment 1, wherein the edges are rounded so as to form rounded concrete shapes.

The concrete mold of embodiment 1, wherein an angle of a wall of the concrete mold and the base is between 0.1 degrees and 90 degrees.

The concrete mold of embodiment 1, wherein one or more removable objects are placed on top of the base and between the walls of the concrete mold.

The concrete mold of embodiment 10, wherein dimensions of the removable objects are between 8 inches and 16 inches.

A method of creating a plastic mold from a template form comprising
Providing a template form similar to claim 1, wherein the base further comprises a second base, wherein disposed within the secondary base are at least three support members, wherein the at least three support members each comprises at least one void area;
disposing a sheet of plastic over the template form;
vacuuming the sheet of plastic so that the sheet of plastic takes on the substantially the template form; and
Removing the template form.

Method of using a plastic mold/providing a plastic mold/applying a releasing agent adding a headstone, pouring concrete, adding at least one lifting accessory, work out air bubbles/waiting a period of time, removing slabs by lifting the concrete slab via the lifting accessory. The concrete mold of claim 1, wherein the one or more slots are between 7 and 9 inches from a nearest corner. In some embodiments, the concrete mold of claim 1, wherein a distance between the one or more slots and a nearest corner of the concrete mold is 36 inches. In some embodiments, the concrete mold of claim 1, wherein a distance between slots is 12 inches. In some embodiments, the concrete mold of claim 1, wherein the base, walls, and dividers are cut out of a sheet of metal. In some embodiments, the concrete mold of claim 1, wherein the edges are rounded so as to form rounded concrete shapes. In some embodiments, the concrete mold of claim 1, wherein an angle of a wall of the concrete mold and the base is between 0.1 degrees and 90 degrees. In some embodiments, the concrete mold of claim 1, wherein one or more removable objects are placed on top of the base and between the walls of the concrete mold. In some embodiments, the concrete mold of claim 10, wherein dimensions of the removable objects are between 8 inches and 16 inches. A method of using a plastic mold to form a concrete slab may include providing a plastic mold (see above). A divider for a concrete mold comprising:
a body comprising:
a front side;
a back side;
a bottom portion;
a top portion;
wherein the top portion has an extended portion which extends beyond a width of the bottom portion on both ends of the divider;
the ends of the extended portion having one or more anchoring projections directed toward the bottom portion of the divider;
wherein the anchoring projections may be inserted into slots of a concrete mold or concrete mold divider;
a flange protruding perpendicularly from the top edge of the divider;
the flange having one or more slots allowing one edge of an insertable divider to be inserted therein.

The divider of claim 13, wherein a plurality of anchoring projections are on one side of the body of the divider.

The divider of claim 13, wherein a plurality of anchoring projections are on both sides of the body of the divider.

The concrete mold of claim 1, further comprising a first horizontally-aligned wall coupled to the base;
a second horizontally-aligned wall coupled to the base, the second horizontally-aligned wall opposing the first horizontally-aligned wall;
a first vertically-aligned wall coupled to the base;
a second vertically-aligned wall coupled to the base;
wherein a top edge of one or more walls contains one or more slots along a length the top edge;
the one or more slots allowing anchors of an insertable divider to be inserted therein, the insertable divider having a front portion, a back portion, a top edge, a left edge, a right edge, and a bottom edge;
wherein the insertable divider, when inserted into slots of opposing walls, subdivides the concrete mold into multiple compartments;
wherein the concrete mold is adaptable to accept a variety of configurations of one or more insertable dividers.

The concrete mold of claim 1, wherein the one or more slots are holes in a flange which extends perpendicularly from the top edge of one or more walls.

The concrete mold of claim 1, wherein the one or more slots are concave grooves in the top edge of one or more walls which extend a width of the wall.

The method of claim 13, wherein additional aspects of claims may depend from any other claim and are directed at adding at least one divider to form at least two compartments; adding at least one accessory: headstone, vase holder, line holder, removable horizontally aligned bolt (taping); adding all of the following accessories: headstone, vase holder, line holder, removable horizontally aligned bolt (taping); method of using a metal mold; inserting a liner (plastic); applying a releasing agent; inserting at least one accessory selected from the group consisting of a headstone, vase holder, side bolt that may be coupled to a bolt receiver which may be cylindrical and threaded; pouring concrete; adding at least one accessory: headstone, vase holder, line holder, removable horizontally aligned bolt (taping); adding all of the following accessories: headstone, vase holder, line holder, removable horizontally aligned bolt (taping).

What is disclosed but not currently claimed:

Embodiment 101. A concrete-casting mold system 99 comprising
a concrete-casting mold 301, the concrete-casting mold 301 comprising
a base 318 (4a) comprising an upper smooth flat surface 326 (4a),
a plurality of walls 311 (4a), the plurality of walls 311 comprising
   a first sloped wall 310 comprising a major upper length element 310a;
   a second sloped wall 312 adjacent to the first sloped wall 310, the second sloped wall 312 comprising a major upper length element 312b;
   a third sloped wall 314 opposing the first sloped wall 310, the third sloped wall 314 comprising a major upper length element 314a;
   a fourth sloped wall 316 opposing the second sloped wall 312, the fourth sloped wall 316 comprising a major upper length element 316a, wherein the first sloped wall 310, the second sloped wall 312, the third sloped wall 314, and the fourth sloped wall 316 are each undetachably coupled to the base 318;
      wherein the plurality of walls 311 and the base 318 collectively define an internal cavity 328 having a height equal to at least 6 inches, the internal cavity 328 comprising
      a lower internal perimeter 320 being substantially 36 inches by substantially 80 inches; and,
      an upper internal perimeter 322 being substantially 30.6 inches by substantially 81.6 inches,

Embodiment 102. The concrete-casting mold system 99 of Embodiment 101, wherein the concrete-casting mold 301 comprises plastic material or plastic-composite material, wherein the second sloped wall 312 further comprises a first recess pair comprising
a first recess and a second recess, wherein the first recess is disposed along the major upper length element of the second sloped wall 312, the first recess directly opposing the second recess disposed along the major upper length element of the fourth sloped wall 316.

Embodiment 103. The concrete-casting mold system 99 of Embodiment 102, wherein the second sloped wall 312 further comprises a second recess pair comprising
a third recess and a fourth recess, wherein the third recess is disposed along the major upper length element of the second sloped wall 312, the third recess directly opposing a fourth recess disposed along the major upper length element of the fourth sloped wall 316; wherein the second sloped wall 312 further comprises a third recess pair comprising
a fifth recess and a sixth recess, wherein the fifth recess is disposed along the major upper length element of the second sloped wall 312, the fifth recess directly opposing a sixth recess disposed along the major upper length element of the fourth sloped wall 316; wherein the second sloped wall 312 further comprises a fourth recess pair comprising a seventh recess disposed along the major upper length element of the second sloped wall 312, the seventh recess directly opposing an eighth recess disposed along the major upper length element of the fourth sloped wall; wherein a detachable barrier wall further comprises a first elongated flange and second elongated flange, wherein the detachable barrier wall is coupled via the first elongated flange and the second elongated flange to one of the recess pairs.

Embodiment 104. (for the long divider) The concrete-casting mold system 99 of Embodiment 103, wherein the first sloped wall 310 further comprises a fifth recess pair comprising
a ninth recess and a tenth recess, wherein the ninth recess is disposed along the major upper length element of the first sloped wall 310, wherein the tenth recess is disposed along the major upper length element of the third sloped wall 314.

Embodiment 105. (The concrete-casting mold system 99 of Embodiment 104 wherein the (measured from the inner wall) first recess pair is located at a location between 34.2 inches 37.8 inches from the first wall, wherein the second recess pair is located at a location between 45.6 inches and 50.4 inches from the first wall, wherein the third recess pair is located at a location between 57 inches and 63 inches from the first wall, wherein the fourth recess pair is located at a location between 68.4 inches and 75.6 inches from the first wall, wherein the fifth recess pair is located at a location between 28.5 inches and 31.5 inches from a point of intersection between the second sloped wall 312 and the third sloped wall 314.

Embodiment 106. The concrete-casting mold system 99 of Embodiment 101, wherein the concrete-casting mold 301 is a metal mold 325.

Embodiment 107. The concrete-casting mold system 99 of Embodiment 106, wherein the major upper length element of the first sloped wall 310 further comprises at least one notch pair configured to detachably secure a first prong pair, wherein the major upper length element of the third sloped wall 310 further comprises at least one notch pair, wherein the major upper length element of the second sloped wall 312 further comprises at least one notch pair, wherein the major upper length element of the fourth sloped wall 316 further comprises at least one notch pair, Wherein notch pair has two adjacent notches configured to receive two adjacent prongs of a detachable barrier wall; as shown in the figure, a user may take a metal barrier wall and use it to divide the metal mold into at least compartments, the user may take a distal end of the detachable barrier wall which may have a distal prong pair, and the user may insert the distal prong pair into a notch pair of a wall of the mold; then the user may take the proximal prong pair of the same detachable barrier wall and then insert the proximal prong pair into a notch pair of a wall that is proximal to the user, which may be the notch pair that allows the barrier wall to be parallel to two of the walls of the mold and also perpendicular to the remaining two walls of the mold; a flange that is located between the two notches of a notch pair assist with securing the two prongs of prong pair.

Embodiment 108. The concrete-casting mold system 99 of Embodiment 106, wherein the major upper length element of the first sloped wall 310 further comprises at least three notch pairs, wherein the major upper length element of the third sloped wall 310 further comprises at least three notch pairs, wherein the major upper length element of the second sloped wall 312 further comprises at least three notch pairs, wherein the major upper length element of the fourth sloped wall 316 further comprises at least three notch pairs.

Embodiment 109. The concrete-casting mold system 99 of Embodiment 108, further comprising
a short detachable barrier wall comprising
   a first flange, the first flange comprising a first prong 400 and a second prong 402, the first prong and the second prong being inserted into a notch pair of the at least two notch pairs of the second sloped wall 312 so as to stabilize the short detachable barrier; and,
   a second flange, the second flange comprising a third prong and a fourth prong, the third prong and the fourth prong being inserted into a notch pair of the at least two notch pairs of the fourth sloped wall 316 so as to stabilize the short detachable barrier.

Embodiment 110. The concrete-casting mold system 99 of Embodiment 108, further comprising
a long detachable barrier wall comprising
   a third flange, the third flange comprising a fifth prong and a sixth prong, the fifth prong and the sixth prong being inserted into a notch pair of the at least one notch pair of the first sloped wall 310 so as to stabilize the long detachable barrier; and,
   a fourth flange, the fourth flange comprising a seventh prong and an eighth prong, the seventh prong and the eight prong being inserted into a notch pair of the at least six notch pairs of the fourth sloped wall 316.

Embodiment 111. (T-form) The concrete-casting mold system 99 of Embodiment 109, wherein the short detachable barrier wall comprises a major upper length element, wherein at least one notch pair is disposed along the major upper length element of the short detachable barrier, wherein the concrete-casting mold system 99 of Embodiment 109 further comprises a
a medium-length detachable barrier wall comprising,
   a fifth flange, the fifth flange comprising a ninth prong and a tenth prong, the ninth prong and the tenth prong being inserted into the at least one notch pair disposed along the major upper length element of the short detachable barrier
   wall; and, a sixth flange, the sixth flange comprising an eleventh prong and a twelfth prong, the eleventh prong and the twelfth prong being inserted into a notch pair of the at least six notch pairs of the fourth sloped wall 316.

Embodiment 112. The concrete-casting mold system of Embodiment 111 further comprising a plurality of parallel support bars coupled to the base.

Embodiment 113. A method for molding concrete comprising:
providing a plastic mold;
inserting dividing walls into a concrete mold to form at least two compartments;
pouring concrete into two of the compartments;
applying a releasing agent;
inserting and caulking an inverted headstone to the upper surface of the base;
pouring concrete;
creating an anchor point via submerging a threaded hollow tube, having ends covered, lush below the surface of the wet concrete but at least ¼ inch above the upper surface of the base;
adding a lifting device;
waiting for concrete to dry;
removing bubbles from the surface;
when the concrete is dry, remove the concrete slab via the lifting device;
invert the concrete slab against a wall of the plastic mold;
inserting lifting devices and eliminating air bubbles; and,
removing concrete once it has solidified.

Embodiment 114. The concrete mold of Embodiment 101, wherein corners and edges of the concrete mold are rounded.

Embodiment 115. A method for molding concrete comprising:
inserting dividing walls into a concrete mold;
applying a releasing agent;
inserting and caulking surface accessories;
inserting lifting devices and eliminating air bubbles;
removing concrete once it has solidified.

Embodiment 116. The method of Embodiment 115, wherein the concrete mold is plastic that has been vacuumed into a shape of the mold.

Embodiment 117. The method of Embodiment 115, wherein the concrete mold is metal with an inserted plastic liner.

Embodiment 118. The method of Embodiment 116, wherein concrete is removed from the concrete mold with one or more rings being placed into the concrete before it has dried; Embodiment 119. The method of Embodiment 116, wherein a cylinder may be attached to a base of a concrete form so as to form a depression in the concrete form, wherein at least one option selected from group consisting of where divider has at least 2 tabs—tabs is another term for prongs or anchoring projections in the context of a barrier wall—wherein divider has 3 tabs or four tabs—wherein the divider has two prongs—prong pair—on each side.

What is claimed:

1-29. (canceled)

30. A concrete-casting mold system comprising
a concrete-casting mold, the concrete-casting mold comprising
a base comprising an upper smooth flat surface,
a plurality of walls, the plurality of walls comprising
a first sloped wall comprising a major upper length element;
a second sloped wall adjacent to the first sloped wall, the second sloped wall comprising a major upper length element;
a third sloped wall opposing the first sloped wall, the third sloped wall comprising a major upper length element;
a fourth sloped wall opposing the second sloped wall, the fourth sloped wall comprising a major upper length element, wherein the first sloped wall, the second sloped wall, the third sloped wall, and the fourth sloped wall are each undetachably coupled to the base;
wherein the plurality of walls and the base collectively define an internal cavity having a height equal to at least 6 inches, the internal cavity comprising
a lower internal perimeter being substantially 36 inches by substantially 80 inches; and,
an upper internal perimeter being substantially 30.6 inches by substantially 81.6 inches.

31. A method of using a mold to form a concrete slab
providing a mold;
providing a plastic mold;
inserting dividing walls into a concrete mold to form at least two compartments;
pouring concrete into two of the compartments;
applying a releasing agent;
inserting and caulking an inverted headstone to the upper surface of the base,
pouring concrete,
creating an anchor point via submerging a threaded hollow tube, having ends covered, flush against a wall of the mold below the surface of the wet concrete but at least ¼ inch above the upper surface of the base;
adding lifting device;
waiting for concrete to dry;
removing bubbles from the surface;
when the concrete is dry,
remove the concrete slab via the lifting device;
attach bolt to threaded hollow tube, an end of the bolt extending beyond the edge of the concrete;
inserting lifting devices and eliminating air bubbles; and,
inverting the concrete slab.

32. A method of using a metal mold comprising:
Providing a metal mold comprising four walls and a base; wherein the four walls comprise at least 60 notches along the upper edge of the four walls,
Disposing a divider comprising a wall portion and four prongs into the mold by inserting two adjacent prongs into two adjacent notches of a first wall and then inserting two adjacent prongs into two adjacent notches of an opposing wall; and,
pouring concrete.
